(19) United States
(12) Patent Application Publication
(10) Pub. No.: US 2005/0093184 A1
(43) Pub. Date: May 5, 2005

(54) Carbonic water production apparatus and carbonic water production method

(75) Inventors: Yoshinori Nagasaka, Tokyo (JP); Hiroki Sakakibara, Tokyo (JP); Yuichi Morioka, Nagai-shi (JP); Katsuya Sanai, Tokyo (JP); Michio Kanno, Tokyo (JP); Satoshi Takeda, Nagoya-shi (JP)

Correspondence Address: FITCH, EVEN, TABIN & FLANNERY, P. O. BOX 65973, WASHINGTON, DC, 20035, US

(73) Assignees: Mitsubishi Rayon Engineering Co., Ltd., Tokyo (JP); Mitsubishi Rayon Co., Ltd., Tokyo (JP)

(21) Appl. No.: 11/001,333

(22) Filed: Dec. 1, 2004

Related U.S. Application Data
(62) Division of application No. 10/258,031, filed on Oct. 18, 2002.

(30) Foreign Application Priority Data
Apr. 18, 2000 (JP) 2000-116501
Apr. 18, 2000 (JP) 2000-116502
Apr. 18, 2000 (JP) 2000-116503
Aug. 10, 2000 (JP) 2000-242601
Aug. 21, 2000 (JP) 2000-249738
Aug. 30, 2000 (JP) 2000-260701

(51) Int. Cl. C02F 1/76

(52) U.S. Cl. 261/122.1

(57) ABSTRACT

A carbonic water production apparatus equipped with a carbonic acid gas dissolving apparatus 3 and a circulation pump 1 wherein water in a bath 11 is circulated by the circulation pump 1, and a carbonic acid gas is fed into the carbonic acid gas dissolving apparatus 3 to dissolve the carbonic acid gas in the water, and wherein the circulation pump 1 is a positive-displacement metering pump having a self-priming ability; a carbonic water production method using this apparatus; a carbonic water production method comprising an early step for producing a carbonic water and a concentration maintaining step for the carbonic water; a carbonic water production apparatus equipped with a control for controlling the feeding pressure of carbonic water gas so that give an intended concentration of carbonic acid gas; a carbonic water production apparatus which automatically discharges out a drain; and a carbonic water production apparatus combined with a portable foot bath.

### TECHNICAL FIELD

The present invention relates to an apparatus and a method for producing carbonic a water which is useful, for example, in hydrotherapy for the purpose of improving physiological functions.

### BACKGROUND ART

Carbonic water is assumed to be effective for treatment of regressive diseases and peripheral circulatory disorders. For example, there is a method in which a carbonic acid gas is fed in the form of bubble into a bath (bubbling method), as a method of artificially producing carbonic water. However, the dissolving ratio is low, and the dissolution time is long in this method. Further, there is a chemical method in which a carbonate salt is reacted with an acid (chemical method). However, it is necessary to add chemical materials at a large amount, and it is impossible to keep a clearness in this method. Furthermore, there is a method in which hot water and a carbonic acid gas are sealed in a tank for a period while it is pressured (pressured method). However, the size of the apparatus increases impractically in this method.

Currently, commercially marketed apparatuses of producing carbonic water is usually for producing a carbonic water having a low concentration of carbonic acid gas which is about 100 to 140 mg/L. The apparatuses have no means of controlling the concentration of carbonic acid gas.

On the other hand, Japanese Patent Application Laid-Open (JP-A) No. 2-279158 discloses a method in which a carbonic acid gas is fed through a hollow fiber semi-permeable membrane and absorbed by hot water. Further, JP-A No. 8-215270 discloses a method in which a pH sensor is put in a bath, and there is controlled the feeding rate of carbonic acid gas into a carbonic acid gas dissolving apparatus for maintaining the concentration of carbonic acid gas of water in the bath at constant level. Furthermore, International Publication No. 98/34579 pamphlet discloses a method in which a concentration data of carbonic acid gas of carbonic water produced is calculated from the pH value of carbonic water and the alkalinity of raw water, and the feeing rate of carbonic acid gas is controlled so that the concentration of carbonic acid gas of carbonic water becomes to be an intended value. These are methods in which a carbonic water is produced by passing once raw water through in the carbonic acid gas dissolving apparatus equipped with a hollow membrane, and the apparatus is called as one-pass type apparatus.

In the one-pass type apparatus, it is necessary to increase the membrane area of the hollow fiber membrane or increase the pressure of carbonic acid gas in order to produce a carbonic water having a high concentration which is excellent in physiological effects (e.g., blood flow increase). However, if the membrane area is increased, the size of apparatus is increased, and it causes to increase the cost. If the pressure of gas is increased, the dissolving ratio becomes low. Furthermore, in the one-pass type apparatus, it is indispensable to operate a piping and a hose connecting between the apparatus and hot water such as a tap water. As a result, the setting is necessary in every case that the apparatus is moved for using at any places.

On the other hand, a carbonic water having a high concentration can be produced efficiently at low cost by a so-called circulation type apparatus wherein hot water in a bath is circulated by a circulation pump through a carbonic acid gas dissolving apparatus. Additionally, the setting of the circulation type apparatus is very simple because it needs no connecting work as in the one path type apparatus, and because it is completed only by filling a bath with hot water and putting a carbonic water circulation hose of the apparatus in the bath. The examples of such circulation type carbonic water apparatus include apparatuses disclosed by JP-A Nos. 8-215270 and 8-215271.

Under a condition in which carbonic water having a desired concentration of carbonic acid gas is filled in the bath, the carbonic acid gas in the carbonic water is evaporated, and it results to gradually decrease the concentration of carbonic acid gas. This tendency depends on the size of bath. Particularly, when a large bath for a plenty of people is filled with a carbonic water, its evaporation amount is large, and the concentration of carbonic acid gas is quickly decreased. In the large bath for a plenty of people, the hot water is often circulated through a filtration apparatus for cleaning the hot water even when the bath is used. However, the carbonic acid gas is evaporated in a large amount at the filtration apparatus if the carbonic water is filled in such circulation type bath in which the water is circulated through the filtration apparatus.

The method in which the feeding amount of carbonic acid gas is controlled based on the pH value, makes a relatively large calculating error in the concentration of carbonic acid gas in the resulting carbonic water. Therefore, it is necessary to add an automatically correcting function to the pH sensor for suppressing the calculating error thereof within ±0.05. This needs complicated control, and increases the size of the apparatus and the cost. Additionally, the alkalinity of raw water (e.g., tap water) should be measured to control precisely the concentration of carbonic acid gas.

The examples of carbonic acid gas production apparatuses include so-called one-pass type apparatuses as disclosed in JP-A No. 2-279158 and International Publication No. 98/34579 pamphlet in which carbonic water is produced by passing once raw water through in a carbonic acid gas dissolving apparatus equipped with a hollow fiber membrane, and so-called circulation type apparatuses as disclosed in JP-A Nos. 8-215270 and 8-215271 in which hot water in a bath is circulated through a carbonic acid gas dissolving apparatus by a circulation pump. In any type apparatus, water as drain is collected at outside parts of the hollow fiber membrane. The water as drain is one permeated through the membrane from the hollow part of hollow fiber membrane, or one generated by condensation of vapor permeated through the membrane from the hollow part. When the drain comes in contact with the surface of membrane, the surface is clogged, and the gas permeation cannot be effectively performed. In conventional apparatuses, an operator appropriately opens a drain valve to discharge the drain collected at the outside parts of hollow fiber membrane.

There is conventionally known a foot bath of carbonic water intending an improvement in physiological functions of foot. In the conventional foot bath, it is necessary that the foot bath is filled with a carbonic water previously produced, or that a carbonic water is produced from hot water filled in the bath by using another apparatus. These operations are complicated for use. Particularly, a portable type foot bath has a merit that the foot bath treatment can be simply conducted without selecting places, but the merit is restricted by the operations for producing the carbonic water.

### DISCLOSURE OF INVENTION

The first object of the present invention is to realize a more practical circulation type carbonic water production apparatus, and to provide an apparatus and a method that can produce a carbonic water having a desired concentration of carbonic acid gas (particularly, so high concentration that physiological effects are obtained) through a simple operation at low cost.

The second object of the present invention is to provide a method of producing carbonic water which can solve the problem of evaporation of carbonic acid gas, and can produce and maintain a certain concentration of carbonic acid gas for a long period through a simple operation at low cost.

The third object of the present invention is to provide an apparatus and a method that can produce a carbonic water always having a certain concentration of carbonic acid gas (particularly, so high concentration that physiological effects are obtained) through a simple operation at low cost, and is irrespective of the flow rate of raw water.

The fourth object of the present invention is to realize a more practical carbonic water production apparatus, and to provide an apparatus and a method that can produce a carbonic water through a simple operation.

The fifth object of the present invention is to provide a carbonic water production apparatus that can be used by a simple operation, and keep the merit of portable foot bathes.

The first present invention relates to a carbonic water production apparatus which is equipped with a carbonic acid gas dissolving apparatus and a circulation pump wherein water in a water tank is circulated through the carbonic acid gas dissolving apparatus by the circulation pump, and a carbonic acid gas is fed into the carbonic acid gas dissolving apparatus to dissolve the carbonic acid gas in the water, and which is characterized in that the circulation pump is a positive-displacement metering pump having a self-priming ability; and, a carbonic water production method which comprises circulating water in a water tank through a carbonic acid gas dissolving apparatus by a circulation pump, and feeding a carbonic acid gas into the carbonic acid gas dissolving apparatus to dissolve the carbonic acid gas in the water, and which is characterized in that a positive-displacement metering pump having a self-priming ability is used as the circulation pump.

Regarding conventional circulation type carbonic water apparatuses, JP-A No. 8-215270 discloses no investigation about which kind of circulation pump is suitable for production of carbonic water. JP-A No. 8-215270 discloses an underwater pump used as the circulation pump. However, bubbling of the circulated carbonic water is significantly caused by swirling pumps such as the underwater pump when the carbonic water has a high concentration, and the bubbling may reduce the pump discharge amount and pump head. In the worst case, blades of the pump often idles so that it becomes impossible to circulate the carbonic water.

On the other hand, according to the first present invention, a carbonic water can be successfully circulated even if the carbonic water has a high concentration because a positive-displacement metering pump having a self-priming ability is used. It results that a water tank can be filled with carbonic water having a high concentration.

The second present invention relates to a carbonic water production method which comprises circulating water in a water tank through a carbonic acid gas dissolving apparatus by a circulation pump, and feeding a carbonic acid gas into the carbonic acid gas dissolving apparatus to dissolve the carbonic acid gas in the water, and which is characterized by comprising an early step of applying a necessary pressure of the carbonic acid gas in order to produce a carbonic water having a desired concentration of carbonic acid gas, in the early circulation of the water for producing the carbonic water, and a concentration maintaining step of applying a necessary pressure of the carbonic acid gas and circulating the carbonic water in order to maintain the desired concentration of carbonic acid gas of the carbonic water produced at the early step.

The second present invention is a method in which a carbonic water having a high concentration is efficiently produced at the early step, and furthermore, the concentration of carbonic acid gas is maintained by also applying the carbonic acid gas process to water which is circulated for cleaning in use, particularly in use of a large bath for a plenty of people. This method can produce and maintain a certain concentration of carbonic acid gas for a long period through a simple operation at low cost.

The third present invention relates to a carbonic water production apparatus which feeds a carbonic acid gas into a carbonic acid gas dissolving apparatus thereof while flowing a raw water therein to dissolve the carbonic acid gas in the raw water, and which is characterized by being previously recorded a correlation data of the flow rate of raw water with the feeding pressure of carbonic acid gas and the concentration of carbonic acid gas in resulted carbonic water, and is equipped with a means for detecting the flow rate of raw water and controlling the feeding pressure of carbonic acid gas according to the correlation data so that the resulted carbonic water has an intended concentration of carbonic acid gas at the time of producing the carbonic water; and a carbonic water production method which comprises feeding a carbonic acid gas into a carbonic acid gas dissolving apparatus while flowing a raw water to dissolve the carbonic acid gas in the raw water, and which is characterized by comprising a step of previously recording a correlation data of the flow rate of raw water with the feeding pressure of carbonic acid gas and the concentration of carbonic acid gas in resulted carbonic water, and a step of detecting the flow rate of raw water and controlling the feeding pressure of carbonic acid gas according to the correlation data so that the resulted carbonic water has an intended concentration of carbonic acid gas at the time of producing the carbonic water.

According to the third present invention, the carbonic water always having a certain high concentration can be produced by a simple operation at low cost without depending on the flow rate of raw water, as compared with a conventional method in which the feeding amount of carbonic acid gas is controlled based on the pH measured value.

The fourth present invention relates to a carbonic water production apparatus which is equipped with a membrane type carbonic acid gas dissolving apparatus, and which is characterized by being equipped with an automatic water extraction means for automatically discharging out the drain accumulated in the membrane type carbonic acid gas dissolving apparatus; and a carbonic water production method which applies a membrane type carbonic acid gas dissolving apparatus, and which is characterized by comprising a step of automatically discharging out the drain accumulated in the membrane type carbonic acid gas dissolving apparatus.

According to the fourth present invention, an effective membrane area can be always ensured and a carbonic water having a high concentration can be successfully produced by a simple operation without manual drain extraction by hand-operated.

The fifth present invention relates to a carbonic water production apparatus which is characterized by being combined with a portable foot bath.

In the fifth present invention, the term “portable” means that the foot bath is not fixed at a certain place, and if necessary, can be carried and moved. The carrying method is not particularly restricted. According to the fifth present invention, a bath can be provided, which can be used by a simple operation, and keep the merit of portable foot bathes.

### BRIEF DESCRIPTION OF DRAWINGS

FIG. 1 is a flow sheet showing one example using a circulation type carbonic water production apparatus according to the first present invention.

FIG. 2 is a schematic view showing one example of a three-layer complex hollow fiber membrane.

FIG. 3 is a flow sheet showing one example using a circulation type carbonic water production apparatus according to the first present invention.

FIG. 4 is a graph showing a correlation between the circulation time and the concentration of carbonic acid gas in Example A1.

FIG. 5 is a flow sheet showing one example using a circulation type carbonic water production apparatus according to the second present invention.

FIG. 6 is a flow sheet showing one example using a one-pass type carbonic water production apparatus according to the third present invention.

FIG. 7 is a graph showing a correlation between the flow rate of raw water and the controlled gas pressure of carbonic acid gas in the third present invention.

FIG. 8 is a flow sheet schematically showing one example of application to a carbonic water production and feeding system.

FIG. 9 is a schematic view showing one embodiment of the fifth present invention utilizing a circulation type carbonic water production apparatus.

FIG. 10 is a schematic view showing one embodiment of the fifth present invention utilizing a one-pass type carbonic water production apparatus.

### BEST MODE FOR CARRYING OUT THE INVENTION

[Embodiments of the First Present Invention]

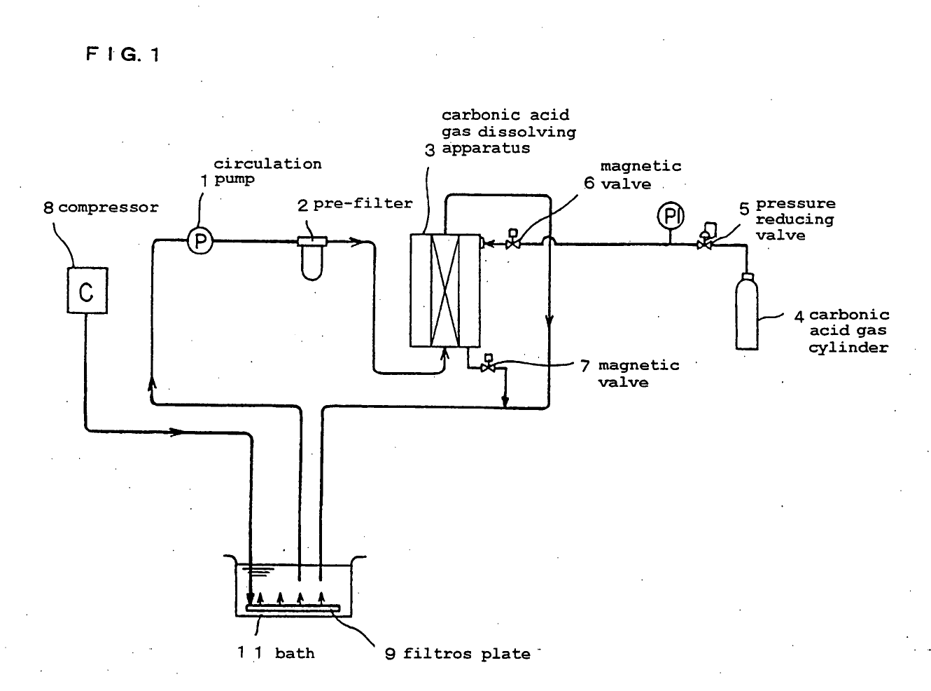

FIG. 1 is a flow sheet showing one example using a circulation type carbonic water production apparatus according to the first present invention. In this example, hot water in the bath (water tank) 11 is circulated the temperature of water in the bath 11 is not particularly restricted. Here, temperatures around body temperature or lower are preferable in order to manifest physiological effects of carbonic water and not to apply surplus load on body and diseased part. Specifically, temperatures of from 32 to 42° C. are preferable.

In this example, water in the bath 11 is circulated. Such applying an apparatus of the present invention to a bath is a very useful example. However, the first present invention is not limited to this. The first present invention can be applied to a water tank except bath, which should be filled with a carbonic water having a desired concentration, such as a water storage tank and a feed water tank.

Water which is a subject to be circulated is not particularly restricted. When water containing no carbonic acid gas at all before circulation is circulated, carbonic water having gradually increasing the concentration of carbonic acid gas will be circulated. Furthermore, higher concentration of carbonic acid gas can be also recovered by circulating a carbonic water having lowered concentration of carbonic acid gas.

In the example shown in FIG. 1, hot water in the bath 11 is sucked up by a circulation pump 1, and introduced into the carbonic acid gas dissolving apparatus 3 via the pre-filter 2 for trapping trashes in the hot water, and returns again to the bath 11. On the other hand, a carbonic acid gas is fed from the carbonic acid gas cylinder 4, via the pressure-reducing valve 5 and the magnetic valve 6 which is a cut off valve for a carbonic acid gas, into the carbonic acid gas dissolving apparatus 3.

The carbonic acid gas dissolving apparatus 3 is a membrane type carbonic acid gas dissolving apparatus constituted of a membrane module having a hollow fiber membrane installed. In this example, a carbonic acid gas fed into the carbonic acid gas dissolving apparatus 3 is introduced onto the outer surface of the hollow fiber membrane. On the other hand, hot water fed in the carbonic acid gas dissolving apparatus 5 flows in a hollow part of the hollow fiber membrane. Here, a carbonic acid gas on the outer surface of the hollow fiber membrane comes into contact with hot water flowing in a hollow part of the hollow fiber membrane via a membrane surface, a carbonic acid gas is dissolved in hot water to produce carbonic water, and this carbonic water is fed into the bath 11. By thus circulating hot water in the bath 11 by the circulation pump 1 for an optional time, carbonic water having high concentration of carbonic acid gas will be filled in the bath 11. When contact and dissolution of a carbonic acid gas are conducted via a membrane surface of a membrane module as in this example, gas-liquid contact area can be increased, and a carbonic acid gas can be dissolved with high efficiency. As such a membrane module, for example, a hollow fiber membrane module, plate membrane module and spiral type module can be used. Particularly, a hollow fiber membrane module can dissolve a carbonic acid gas with highest efficiency.

Hot water in the bath 11 gets increased the concentration of carbonic acid gas with the lapse of time of circulation. When such correlation data between the circulation time and the concentration of carbonic acid gas are previously measured, if the intended concentration of carbonic acid gas and feeding pressure of carbonic acid gas are determined, necessary circulation time can be determined. However, the correlation data cannot be utilized if the circulation water amount is not always constant, therefore, it is necessary to use a metering pump as the circulation pump 1. However, according to knowledge of the present inventors, even in the case of metering pumps, a volute pump and the like cannot provide utilization of correlation data since the pump flow rate also varies by change of head such as clogging of a pre-filter. Additionally, when carbonic water gets high concentration, a pump is stopped by bubble.

Then, according to the first present invention, stable circulation and always constant circulation water amount are realized by using a positive-displacement metering pump having a self-priming ability as the circulation pump 1. This positive-displacement metering pump has a self-priming ability by which activation can be made in the initial operation without priming. Additionally, though carbonic water tends to generate bubble when its concentration increases, this positive-displacement metering pump can convey water stably even under bubble rich condition.

This positive-displacement metering pump is very effective particularly when correlation data between the circulation flow rate of the positive-displacement metering pump, the gas feeding pressure at water amount in water tank, the concentration of carbonic acid gas of carbonic water in a water tank, and the circulation time are previously recorded, and, in producing carbonic water, the circulation time is controlled based on the above-mentioned correlation data, to give a concentration of carbonic acid gas of carbonic water in a water tank in the range from 600 mg/L to 1400 mg/L.

As the positive-displacement metering pump having a self-priming ability, for example, a diaphragm pump, screw pump, tube pump and piston pump are listed. Among recent commercially available products, a diaphragm pump is optimal from the standpoints of price, ability, size and the like. Specifically, there can be used, for example, a 3-head diaphragm pump manufactured by SHURflo (US), 5-head diaphragm pump manufactured by Aquatec Water System (US), 4-head diaphragm pump manufactured by FLOJET (US), and the like. These commercially available products are marketed usually as a booster pump in a beverage filtration apparatus. Namely, these commercially available products have no relation with a carbonic water production apparatus.

The pressure of carbonic acid gas fed to the carbonic acid gas dissolving apparatus 3 is set by the pressure-reducing valve 5. When this pressure is lower, generation of a non-dissolved gas at the carbonic acid gas dissolving apparatus 3 is suppressed, and the dissolution efficiency is higher. The carbonic acid gas permeation amount through a hollow fiber membrane in the carbonic acid gas dissolving apparatus 3 is in proportion to the feeding pressure of carbonic acid gas, and when the pressure is higher, the permeation amount is higher. Judging from these points and since when the carbonic acid gas pressure is lower, the production time is longer, the pressure is appropriately from about 0.01 to 0.3 MPa. The carbonic acid gas absorption amount of circulating hot water depends also on the concentration of carbonic acid gas and circulation water amount of the hot water, and when a carbonic acid gas of over the absorption amount is fed, a non-dissolved gas is formed.

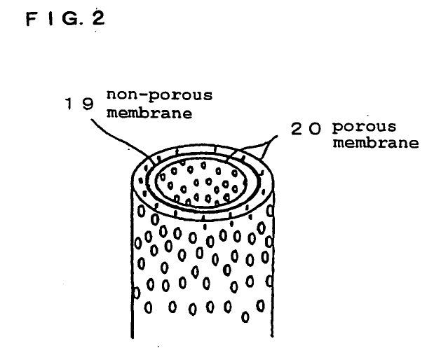

When a hollow fiber membrane is used in the carbonic acid gas dissolving apparatus 5, any material may be used, as this hollow fiber membrane, providing it is excellent in gas permeability, and a porous membrane or non-porous gas permeability membrane (hereinafter, abbreviated as “non-porous membrane”) may be used. As the porous hollow fiber membrane, those having an opening pore diameter on its surface of 0.01 to 10 μm are preferable. A hollow fiber membrane containing a non-porous membrane is also suitably used. The most preferable hollow fiber membrane is a complex hollow fiber membrane of a three-layer structure comprising a non-porous layer in the form of thin membrane both sides of which are sandwiched by porous layers. As its specific example, for example, a three layer complex hollow fiber membrane (MHF, trade name) manufactured by Mitsubishi Rayon Co. Ltd. is mentioned. FIG. 2 is a schematic view showing one example of such a complex hollow fiber membrane. In the example shown in FIG. 2, a non-porous layer 19 is formed as a very thin membrane excellent in gas permeability, and porous layers 20 are formed on its both surfaces, to protect the non-porous layer 19 so that it is not injured.

Here, the non-porous layer (membrane) is a membrane through which a gas permeates by a mechanism of dissolution and diffusion into a membrane substrate, and any membrane can be used providing it contains substantially no pore through which a gas can permeate in the form of gas like Knudsen flow of molecules. When this non-porous membrane is used, a gas can be supplied and dissolved without discharging a carbonic acid gas in the form of bubble into hot water, therefore, efficient dissolution is possible, additionally, a gas can be dissolved simply under excellent control at any concentration. Further, there is no counterflow which occurs uncommonly in the case of a porous membrane, namely, hot water does not counter-flow to the gas feeding side through fine pores.

The thickness of a hollow fiber membrane is preferably 10 to 150 μm. When the membrane thickness is 10 μm or more, sufficient membrane strength tends to be shown. When 150 μm or less, sufficient carbonic acid gas permeation speed and dissolving efficiency are liable to be shown. In the case of a three-layer complex hollow fiber membrane, the thickness of a non-porous membrane is preferably 0.3 to 2 μm. When the membrane thickness is 0.3 μm or more, the membrane does not easily deteriorate, and leak due to membrane deterioration does not occur easily. When 2 μm or less, sufficient carbonic acid gas permeation speed and dissolving efficiency are liable to be shown.

When the water passing amount per hollow fiber membrane module is 0.2 to 30 L/min and the gas pressure is 0.01 MPa to 0.3 MPa, it is preferable that the membrane area is about 0.1 m² to 15 m².

As the membrane material of a hollow fiber membrane, for example, silicone-based, polyolefin-based, polyester-based, polyamide-based, polysulfone-based, cellulose-based and polyurethane-based materials and the like are preferable. As the material of a non-porous membrane of a three-layer complex hollow fiber membrane, polyurethane, polyethylene, polypropylene, poly4-methylpentene-1, polydimethylsiloxane, polyethylcellulose and polyphenylene oxide are preferable. Among them, polyurethane manifests excellent membrane forming property and provides little eluted substance, therefore, it is particularly preferable.

The internal diameter of a hollow fiber membrane is preferably 50 to 1000 μm. When the internal diameter is 50 μm or more, the flow route resistance of fluid flowing in a hollow fiber membrane decreases appropriately, and feeding of fluid becomes easy. When 1000 μm or less, the size of a dissolving apparatus can be decreased, providing a merit in compactness of the apparatus.

When a hollow fiber membrane is used in a carbonic acid gas dissolving apparatus, there are a method in which a carbonic acid gas is fed to the hollow side of a hollow fiber membrane, and hot water is fed to the outer surface side to dissolve the carbonic acid gas, and a method in which a carbonic acid gas is fed to the outer surface side of a hollow fiber membrane and hot water is fed to the hollow side to dissolve the carbonic acid gas. Among them, particularly the latter method is preferable since a carbonic acid gas can be dissolved in high concentration in hot water irrespective of the form of a membrane module.

As the carbonic acid gas dissolving apparatus used in the present invention, there can also be used that having a gas diffusion means in which a gas diffusing part composed of a porous body is set at the bottom in a carbonic acid gas dissolving apparatus. The material and form of a porous body set at a gas diffusing part may be optionally selected, and preferable is that having a void ratio, namely, a volume ratio of voids present in the porous body itself based on the whole porous body, of 5 to 70 vol %. For further enhancing the dissolving efficiency of a carbonic acid gas, that having lower void ratio is suitable, and that having a void ratio of 5 to 40 vol % is more preferable. When the void ratio is 70 vol % or less, flow control of a carbonic acid gas becomes easy, the gas flow rate can be suitably decreased, bubble of a carbonic acid gas diffused from a gas diffusing body does not become big, and dissolution efficiency does not easily lower. When the void ratio is 5 vol % or more, sufficient feeding amount of carbonic acid gas can be maintained, and dissolution of a carbonic acid gas tends to be performed in a relatively short time.

The opening pore diameter on the surface of a porous body is preferably 0.01 to 10 μm, for control of the flow rate of carbonic acid gas diffused, and for formation of fine bubble. When the pore diameter is 10 μm or less, the size of bubble rising in water becomes moderately small, and the dissolution efficiency of a carbonic acid gas increases. When 0.01 μm or more, the gas diffusion amount into water increases moderately, and even in the case of obtaining carbonic water of high concentration, the procedure is completed in a relatively short time.

When a porous body placed in a gas diffusion part of a gas diffusing means has large surface area, bubble can be generated in larger number, contact between a carbonic acid gas and raw water progresses efficiently, and dissolution before formation of bubble also occurs, leading to enhanced dissolution efficiency. Therefore, though the form of a porous body is not valued, that having larger surface area is preferable. As the means of increasing the surface area, there are envisaged various methods such as formation of a porous body in the form of cylinder, formation of a porous body in the form of flat plate and providing irregularity on its surface, and the like, however, it is preferable to use a porous hollow fiber membrane, particularly, utilization of a lot of porous hollow fiber membranes bundled is effective.

The material of a porous body is not particularly restricted though various materials such as metals, ceramics and plastics are exemplified. However, hydrophilic materials are not preferable since hot water invades into a gas diffusing means through pores on its surface in stopping of feeding of a carbonic acid gas.

In the case of feeding a carbonic acid gas to the outer surface side of a hollow fiber membrane and feeding hot water to the hollow side to dissolve the carbonic acid gas, piping for counterflow washing may be provided. When scale accumulates at a potting opening end which is a feeding port to a hollow part of a hollow fiber membrane, this scale can be removed relatively simply by counterflow washing.

Regarding carbonic water produced, its concentration of carbonic acid gas is not particularly restricted. In the above-described example, if a value of a desired concentration of carbonic acid gas is input in the apparatus and hot water in the bath 11 is circulated by the circulation pump 1, then, the apparatus controls the circulation time automatically depending on the desired concentration of carbonic acid gas, consequently, carbonic water having desired concentration of carbonic acid gas is filled in the bath 11.

However, for obtaining medical physiological effects, the concentration of carbonic acid gas of carbonic water is required to be 600 mg/L or more, in general. From this standpoint, the concentration of carbonic acid gas of carbonic water produced in the present invention is also preferably 600 mg/L or more. On the other hand, when the concentration of carbonic acid gas is higher, the dissolution efficiency of a carbonic acid gas lowers, and additionally, at a certain concentration or more, physiological effects do not increase or decrease. From this standpoint, the upper limit of the concentration of carbonic acid gas is adequately about 1400 mg/L.

In the carbonic water production apparatus, a bubble generation apparatus or an injection apparatus can be further provided. The bubble generation apparatus generates bubble in bath water, and the injection apparatus generates water flow in bath water, to impart physical stimulation to a diseased part of body, and owing to its massage effect, to promote blood circulation and to attenuate low back pain, shoulder leaning, muscular fatigue and the like. Such an apparatus is marketed currently by companies, and spread widely in hospitals, senile healthy facilities and homes.

On the other hand, carbonic water produced in the present invention performs an action in which a carbonic acid gas in water is absorbed percutaneously to dilate blood vessels and promote blood circulation. Namely, if an action by bubble and injection is called a dynamic action, an action by carbonic water can be called a static action. Treatment by carbonic water has a merit that no stiff load is applied on a body and a diseased part and little side effect is exerted since it causes no physical stimulation as compared with the bubble generation apparatus and injection apparatus.

In the example shown in FIG. 1, a bubble generating apparatus is further provided on a carbonic water production apparatus according to the first present invention to form one united package which is a multi-functional apparatus capable of carrying out both functions by a one apparatus. The bubble generation apparatus comprises, at least, a gas diffusion plate 9 placed at a lower part in a bath in use, a compressor 8 for feeding air to this gas diffusion plate 9, and piping connecting both of them. By activating the compressor 8, bubble develops from the gas diffusion plate 9, and a physical stimulation is imparted to a diseased part of a man of taking bath.

However, in such as multi-functional apparatus, when a bath is filled with carbonic water, it is recommendable that bubble is not generated. The reason for this is that the content of a bath is stirred by bubble, a carbonic acid gas dissolved in carbonic water easily evaporates into air, and the concentration of carbonic water tends to decrease sharply in less than no time. Therefore, it is preferable that a carbonic water production function and a bubble generation function are not used simultaneously, and a change switch is provided and these functions are carried out separately.

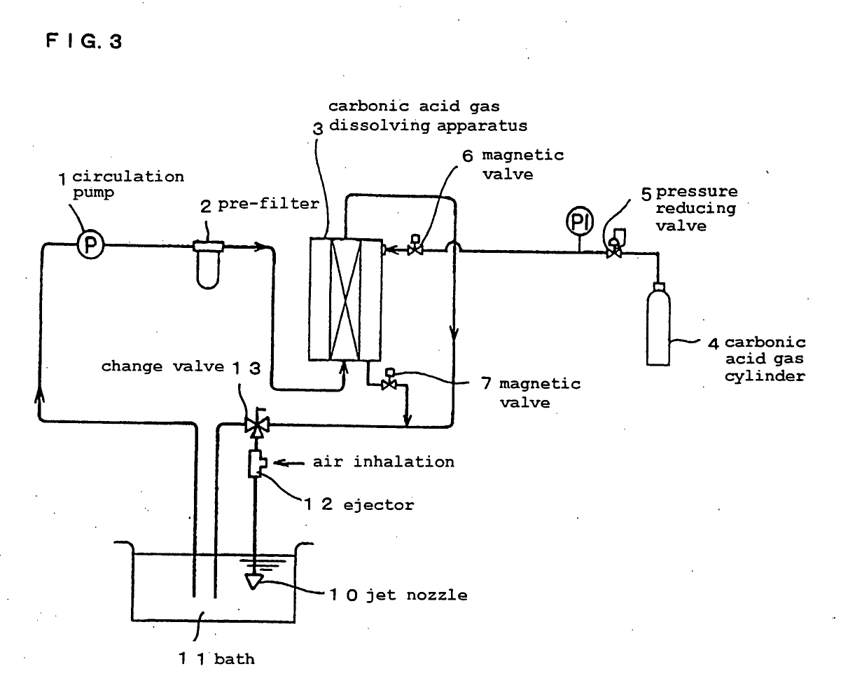

FIG. 3 shows one example of other multi-functional apparatus in a carbonic water production apparatus according to the first present invention. This injection apparatus is composed of, at least, a jet nozzle 10 placed in a bath 11 in use, an ejector 12 absorbing air fed to the jet nozzle 10, and piping connecting them. Water flow, bubble or the like develops from this jet nozzle 10 to impart a physical stimulation to a diseased part of a man taking bath. This water flow or bubble generation function is not used together with production of carbonic water, and they are carried out separately by switching by a switch valve 13.

In the apparatus shown in FIG. 1, an automatic water extraction means is further provided. This automatic water extraction means is composed, specifically, of piping for extracting drain on a hollow fiber membrane in the carbonic acid gas dissolving apparatus 3 and a magnetic vale (open valve) 7 placed on the way of the piping. In the carbonic acid gas dissolving apparatus 3, water vapor evaporated from a hollow part of a hollow fiber membrane is condensed on the outside part of a hollow fiber membrane to collect drain, and this drain clogs the membrane surface and effective gas permeation cannot be effected in some cases. The automatic water extracting means opens the magnetic valve (open valve) 7 automatically and periodically, and discharges drain collected in he carbonic acid gas dissolving apparatus 3 out of the apparatus.

In the example shown in FIG. 1, for example, in the carbonic acid gas dissolving apparatus 3 (hollow fiber membrane area: 0.6 m²), magnetic valve 7 is opened for 1 second in initiation of operation (or in completion), and drain is discharged out. In this procedure, a carbonic acid gas magnetic valve 6 is opened, and drains is discharged under suitable gas pressure (about 0.15 MPa). Discharging out at each operation provides excess frequency, leading to waste of a carbonic acid gas. Therefore, the operation time is integrated, and after each operation for 4 hours or more, automatic water extraction is conducted at the initiation of the next operation.

Thus, by setting gas pressure and time corresponding to the apparatus and conducting drain extraction automatically, there is no necessity to effect manual drain extraction purposely as in conventional technologies, and usually, effective membrane surface area is confirmed, and carbonic water of high concentration can be produced.

[Embodiments of the Second Present Invention]

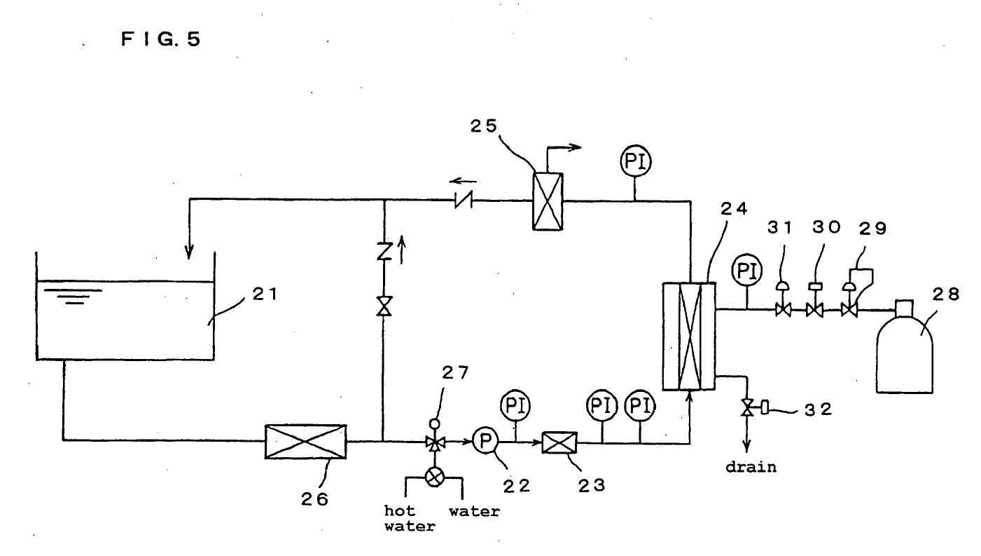

FIG. 5 is a flow sheet showing one example using a circulation type carbonic water production apparatus according to the second present invention.

First, an early step in the second present invention will be explained. In the early step, in this example, hot water in a bath (water tank) 21 circulated. The temperature and application of water in the bath 21 in the second present invention are the same as in the first invention described above. In the example shown in FIG. 5, hot water in this bath 21 is sucked up by a circulation pump 22, and introduced into a carbonic acid gas dissolving apparatus 24 via a pre-filter 23 for trapping trashes in the hot water, and returns again to the bath 21 through a gas extraction chamber 25. Between the bath 21 and the circulation pump 22, a filtrating apparatus 26 for purifying water in the bath is provide, and additionally, a switching valve 27 through which water and hot water are fed is provided. On the other hand, a carbonic acid gas is fed from a carbonic acid gas cylinder 28, via a pressure-reducing valve 29, a magnetic valve 30 which is a cut off valve for a carbonic acid gas and a pressure controlling valve 31 into a carbonic acid gas dissolving apparatus 24.

The circulation pump 22, in the second embodiment of the present invention, is not particularly restricted, and for example, a swirling pump, diaphragm pump, screw pump, tube pump and piston pump commonly used, are listed. The pressure of carbonic acid gas fed to the carbonic acid gas dissolving apparatus 24 is set by the pressure-reducing valve 25. When this pressure is lower, generation of a non-dissolved gas is suppressed, leading to enhanced dissolution efficiency. The carbonic acid gas permeation amount through a hollow fiber membrane in the carbonic acid gas dissolving apparatus 24 is in proportion to the feeding pressure of carbonic acid gas, and when the pressure is higher, the permeation amount is also higher. The carbonic acid gas absorption amount of circulating hot water depends also on the concentration of carbonic acid gas and circulation water amount of the hot water, and when a carbonic acid gas of over the absorption amount is fed, a non-dissolved gas is formed.

Regarding carbonic water produced in the early step, its concentration of carbonic acid gas is not particularly restricted. Hot water in the bath part 21 gets increased concentration of carbonic acid gas with the lapse of time of circulation. When such correlation data between the circulation time and the concentration of carbonic acid gas are previously measured, if the intended concentration of carbonic acid gas and feeding pressure of carbonic acid gas are determined, necessary circulation time can be determined.

The preferable concentration of carbonic acid gas of carbonic water, constitution of the carbonic acid gas dissolving apparatus 24, constitution of a membrane module, constitution of a hollow fiber membrane, preferable range of the feeding pressure of carbonic acid gas, piping for counterflow washing, and automatic water extraction means (piping for drain discharge, magnetic valve (open valve) 32) are the same as in the case of the first invention (FIG. 1).

By the circulation type carbonic water production process described above, namely, by the early step in the second present invention, carbonic water having any high concentration (for example, 600 mg/L to 1400 mg/L) can be produced efficiently. The time of this early step is not particularly restricted, and the early step may be effected until carbonic water having desired concentration of carbonic acid gas is filled in a bath. Usually, it is necessary to effect heating until water in a bath gets suitable temperature, before use of the bath, however, it is preferable that the time of the early step in the second present invention is also about the same as its heating time. This heating time is about 1 hour in the case of a large bath for a plenty of people.

The feeding pressure of carbonic acid gas in the early step is preferably about 0.15 MPa to 0.3 MPa. Values around the lower limit of this pressure are values particularly suitable in the case of a small bath, and values around the upper limit are values particularly suitable in the case of a large bath. In the early step, its pressure is also increased for producing carbonic water of high concentration in a short period of time, however, in the concentration maintaining step, lower pressure than this can be adopted.

Following to this early step, hot water in a bath is further circulated continuously and its high concentration is maintained efficiently, namely, the concentration maintaining step in the second present invention is conducted. This concentration maintaining step is very significant particularly in the case of large bath having large surface area on water surface. The time of this concentration maintaining step is not particularly restricted, however, it is preferable that the concentration maintaining step is conducted during use of a bath. Further, the concentration maintaining step may be effected continuously during use of a bath, or may be effected intermittently at an interval providing the concentration of carbonic acid gas of carbonic water in a bath (for example, 600 mg/L to 1400 mg/L) can be maintained at a desired value. Since, usually, a carbonic acid gas in carbonic water evaporates at a rate of about 1 to 4 mg/L/cm²/Hr per bath area, it may be recommendable that a carbonic acid gas of amount approximately compensating its evaporation is fed and dissolved in carbonic water.

The feeding pressure of carbonic acid gas in the concentration maintaining step is preferably about 0.001 to 0.1 MPa. Values around the lower limit of this pressure are values particularly suitable in the case of a small bath, and values around the upper limit are values particularly suitable in the case of a large bath.

In the second present invention, the size of a bath (water tank) is not particularly restricted, however, a bath having an internal volume of about 0.5 m³ to 3 m³ can be used.

The circulation flow rate per unit area in the concentration maintaining step in the early step is preferably about 5 L/min/m² to 15 L/min/m². The carbonic acid gas permeation flow rate per unit membrane area in a hollow fiber membrane is preferably about 0.2 to 2 L/min/atm/m².

[Embodiments of the Third Present Invention]

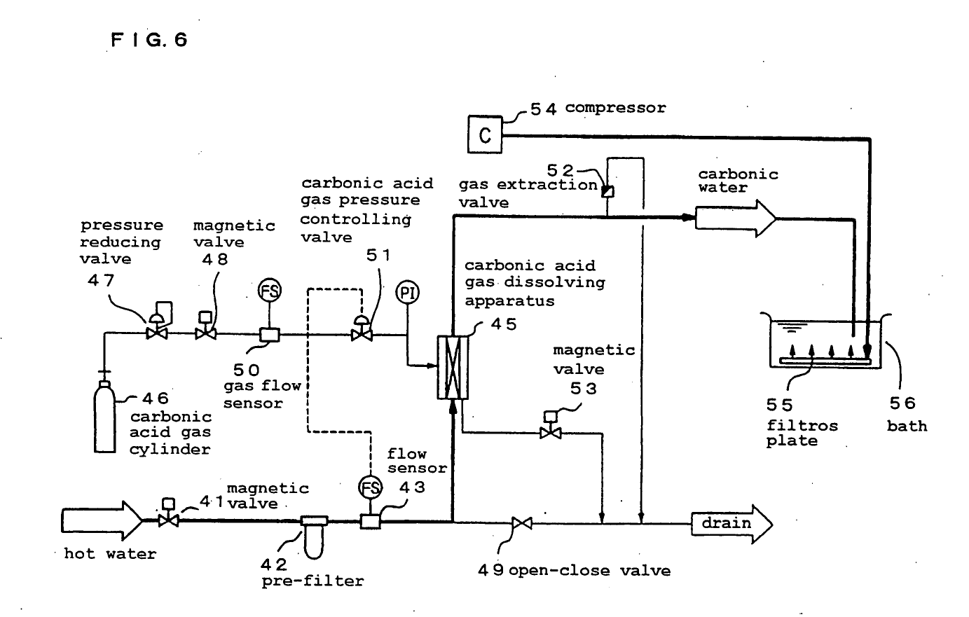

FIG. 6 is a flow sheet showing one example using a one-pass type carbonic water production apparatus according to the third present invention. In this example, hot water directly fed from a hot water faucet of water line and the like is used as raw water. In the third present invention, the temperature and application of water in a bath are the same as in the first invention described above. This hot water is introduced into a carbonic acid gas dissolving apparatus 45 via a magnetic valve 41 which is a cut off valve in raw water feeding, a pre-filter 42 for trapping trashes in the hot water and a flow sensor 43 detecting the flow rate of hot water. On the other hand, a carbonic acid gas is fed from a carbonic acid gas cylinder 46, via a pressure-reducing valve 47, a magnetic valve 48 which is a cut off valve for a carbonic acid gas, a gas flow sensor 50 and a carbonic acid gas pressure controlling valve 51 for controlling the carbonic acid gas pressure, into a carbonic acid gas dissolving apparatus 45. When an excess gas flows by gas leak in piping and the carbonic acid gas dissolving apparatus 45, the magnetic valve 48 is cut off. An apparatus of producing carbonic water by passing raw water through in the carbonic acid gas dissolving apparatus 45 once is called one-pass type apparatus as illustrated above.

In this example, hot water is flown continuously into a hollow part of a hollow fiber membrane in the carbonic acid gas dissolving apparatus 45. By passing through in the carbonic acid gas dissolving apparatus 45, raw water becomes carbonic water, and this carbonic water is fed continuously from the carbonic acid gas dissolving apparatus 45 to a bath 56 through piping. The flow rate of raw water fed into the carbonic acid gas dissolving apparatus 45 (namely, flow rate of raw water passing in the dissolving apparatus 45) can be detected by a flow sensor 43 provided before a raw water feeding part in the carbonic acid gas dissolving apparatus 45.

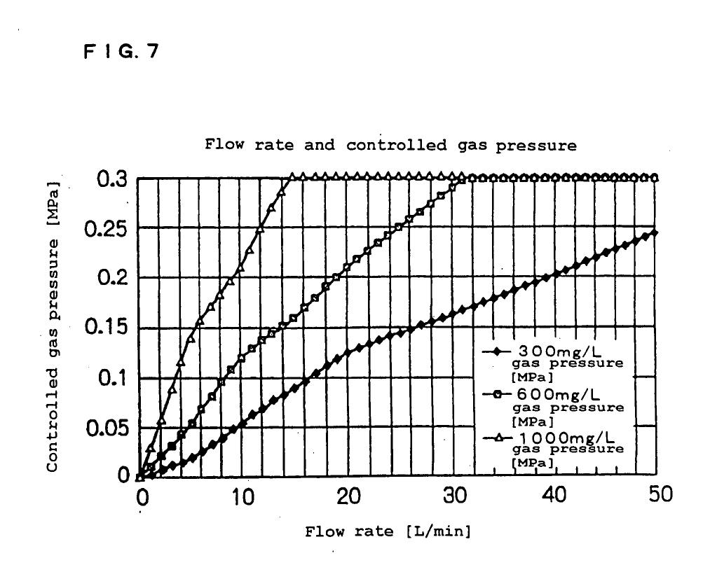

FIG. 7 is a graph showing a correlation between the flow rate [L/min] of raw water flown in the carbonic acid gas dissolving apparatus 45 (hollow fiber membrane area: 2.4 m²) and the controlled gas pressure [MPa] of carbonic acid gas. In this FIG. 7, a correlation between the flow rate of raw water and the controlled gas pressure of carbonic acid gas is shown when the concentration of carbonic acid gas of the resulting carbonic water is 300 mg/L, 600 mg/L and 1000 mg/L. For example, when the feeding pressure of carbonic acid gas is raised, the carbonic acid gas permeation amount in a hollow fiber membrane in the carbonic acid gas dissolving apparatus 43 increases in proportion to this pressure. Therefore, when the flow rate of raw water is large or when the concentration of carbonic acid gas intended is high, the feeding pressure of carbonic acid gas may advantageously be increased correspondingly.

In the third present invention, the correlation as shown in Table 7 is stored previously as a datum and, for example, programmed in a control computer of the apparatus. This datum is used in the following control. First, a user inputs the intended concentration of carbonic acid gas of carbonic water to be obtained, for example, 1000 mg/L, in the apparatus. Then, hot water is fed into the apparatus from a hot water faucet of general water line. The flow rate of hot water is an indefinite factor changing depending on the extent of opening of a faucet. Therefore, this apparatus detects the flow rate which is an indefinite factor in real time by a flow sensor 43. Based on the graph of the correlation (relative data) shown in FIG. 7, a pressure of carbonic acid gas for obtaining carbonic water having a concentration of carbonic acid gas of 1000 mg/L is derived, and the feeding pressure of carbonic acid gas fed to the carbonic acid gas dissolving apparatus 45 is automatically controlled by a carbonic acid gas pressure controlling valve 51. Namely, a program may advantageously be made so that, based on the flow rate of raw water detected by the flow sensor 43 and the relative data recorded previously, a necessary feeding pressure of carbonic acid gas is determined, and the feeding pressure of carbonic acid gas is automatically controlled by a carbonic acid gas pressure controlling valve 51 to reach the determined pressure value.

Regarding a hollow fiber membrane, in general, if the maximum value of the flow rate of raw water is hypothesized about 30 L/min, the feeding pressure of carbonic acid gas is controlled in the range from 0.01 to 0.5 MPa, and the membrane area of a hollow fiber membrane is adequately from about 0.1 m² to 15 m².

In the third present invention, for example, even in the case of feeding raw water from a faucet of water line (namely, when the flow rate of raw water is indefinite), the intended concentration of carbonic acid gas can be obtained with little error. Additionally, since a concentration of carbonic acid gas measuring means and a pH measuring means as used in conventional technologies are not necessary, the apparatus becomes compact and operation thereof is simple. Therefore, for example, provision of a carbonic water production apparatus is not necessarily required in a step of designing a bath, and a compact apparatus simply corresponding to known baths including a domestic bath can be obtained, very practically.

The correlation shown in FIG. 7 is affected also by a gas-liquid contact area (e.g., hollow fiber membrane area). However, in a gas-liquid contact means such as a membrane module used in the apparatus, the gas-liquid contact area is constant. Even if a part is changed, usually, the same product defined as the standard article of the apparatus is used. Namely, in individual apparatus, usually, the gas-liquid contact area is a constant factor. Therefore, the correlation shown in FIG. 7 will take single meaning in one apparatus.

When a hollow fiber membrane is used in the carbonic acid gas dissolving apparatus 45, the thickness of the hollow fiber membrane is preferably from 10 to 150 μm. When the membrane thickness if 10 μm or more, sufficient membrane strength tends to be shown. When 150 μm or less, sufficient carbonic acid gas permeation speed and dissolution efficiency are liable to be shown. In the case of the three-layer complex hollow fiber membrane, the thickness of a non-porous membrane is preferably from 0.3 to 2 μm. When 0.3 μm or more, the membrane does not easily deteriorate, and leak due to membrane deterioration does not occur easily. When 2 μm or less, sufficient carbonic acid gas permeation speed and dissolving efficiency are liable to be shown.

Constitutions other than the thickness of a hollow fiber membrane, preferable concentration of carbonic acid gas of carbonic water, constitution of the carbonic acid gas dissolving apparatus 45, constitution of a membrane module, piping for counterflow washing, automatic water extraction means (piping for drain discharge, magnetic valve (open valve) 53), bubble generating apparatus and injection apparatus are the same as in the case of the first invention (FIG. 1).

In the apparatus shown in FIG. 6, a gas extraction valve 52 is provided at the down flow side of the carbonic acid gas dissolving apparatus 45, namely, a the side of piping through which the produced carbonic water flows. This gas extraction valve 52 communicates with a discharge tube, and removes a non-dissolved carbonic acid gas in the form of bubble contained in carbonic water, and discharges this gas to a drain pipe side.

[Embodiments of the Fourth Present Invention]

As the embodiment of fourth present invention, namely, a carbonic water production apparatus having an automatic water extraction means which automatically discharges drain collected in a membrane type carbonic acid gas dissolving apparatus out of the apparatus, mentioned is, for example, a constitution of the one-pass type carbonic water production apparatus shown in FIG. 6 explained previously as the embodiment of the third present invention. However, in the fourth present invention, a means of controlling the feeding pressure of carbonic acid gas as described in the third present invention is not necessarily required. Excepting these points, constitutions as described in FIG. 6 can be adopted.

Namely, in the apparatus shown in FIG. 6, an automatic water extraction means is provided. This automatic water extraction means is composed, specifically, of piping for extracting drain communicating with the outer side of a hollow fiber membrane in the carbonic acid gas dissolving apparatus 45 and a magnetic vale (open valve) 53 placed on the way of the piping. In the carbonic acid gas dissolving apparatus 45, water vapor evaporated from a hollow part of a hollow fiber membrane is condensed on the outside part of a hollow fiber membrane to collect drain, and this drain clogs the membrane surface and effective gas permeation cannot be effected in some cases. The automatic water extracting means opens the magnetic valve (open valve) 53 automatically and periodically, and discharges drain collected in he carbonic acid gas dissolving apparatus 45 out of the apparatus. In the example shown in FIG. 6, for example, setting is made so that when the follow rate of raw water detected by the flow sensor 43 is 1 L/min or less, the magnetic valve 48 closes to stop feeding of a carbonic acid gas, and by this, production of carbonic water is stopped. And setting is made so that, after feeding of a carbonic acid-gas is thus stopped, given time lapses, then, drain is automatically extracted. Specifically, 10 seconds after this stopping timing, the magnetic valve 53 is opened for about 5 seconds, and drain is discharged out by the remaining pressure of a gas in out of a hollow fiber membrane.

The carbonic acid gas dissolving apparatus may have a constitution in which a carbonic acid gas is fed in a hollow fiber membrane and raw water is flown to the outside of a hollow fiber membrane, contrary to the above-mentioned constitution. In the case of such a constitution, drain extracting piping is communicated to the inside of a hollow fiber membrane in the carbonic acid gas dissolving apparatus.

In stopping of feeding of a carbonic acid gas, there is a possibility that a high pressure of 0.3 MPa at its maximum remains as remaining pressure in the outside of a hollow fiber membrane in the carbonic acid gas dissolving apparatus 45. Therefore, if the magnetic valve 53 is opened directly after stopping of feeding of a carbonic acid gas, a hammer phenomenon may occur. For preventing this, time lag (about 10 seconds) is provided in the above-mentioned example. When a time of about 10 seconds lapses, a gas outside of a hollow fiber membrane permeates appropriately into the hollow side via the membrane, and the remaining pressure outside of a hollow fiber membrane becomes about 0.05 MPa. At remaining pressure of such extent, a hammer phenomenon does not occur, and drain can be discharged sufficiently only by opening the magnetic valve 53 for about 5 seconds.

Namely, in a carbonic water production apparatus of feeding raw water and a carbonic acid gas into the membrane type carbonic acid gas dissolving apparatus 45 to dissolve a carbonic acid gas in raw water as shown in FIG. 6, setting is so made that, in stopping feeding of a carbonic acid gas, after lapse of time (lag time) in which the remaining pressure outside of a hollow fiber membrane in the carbonic acid gas dissolving apparatus 5 permeates to the hollow side to a certain extent and drain can be appropriately discharged, the valve is opened for a sufficient time for extracting drain, automatically. This time lag may be advantageously set so that, particularly, the remaining pressure is preferably about 0.02 to 0.05 MPa, more preferably about 0.02 to 0.03 MPa. Specifically, the time lag is suitably about 5 to 10 seconds. The opening time of the magnetic valve 53 is appropriately from about 3 to 5 seconds.

Further, as the another embodiment of the fourth present invention, mentioned is, for example, a constitution of the circulation type carbonic water production apparatus shown in FIG. 1 explained previously as the embodiment of the first present invention. However, in the fourth present invention, a positive displacement metering pump having a self-priming ability as in the first present invention is not necessarily required. Excepting these points, constitutions as described in FIG. 1 can be adopted.

Namely, in the apparatus shown in FIG. 1, the automatic water extraction means is composed, specifically, of piping for extracting drain in a hollow fiber membrane in the carbonic acid gas dissolving apparatus 3 and a magnetic vale (open valve) 7 placed on the way of the piping. This automatic water extracting means opens the magnetic valve (open valve) 7 automatically and periodically, and discharges drain collected in he carbonic acid gas dissolving apparatus 3 out of the apparatus. For example, in the carbonic acid gas dissolving apparatus 3 (hollow fiber membrane area: 0.6 m²), magnetic valve 7 is opened for 1 second in initiation of operation (or in completion), and drain is discharged out. In this procedure, a carbonic acid gas magnetic valve 6 is opened, and drains is discharged under suitable gas pressure (about 0.15 MPa). Discharging out at each operation provides excess frequency, leading to waste of a carbonic acid gas. Therefore, the operation time is integrated, and after each operation for 4 hours or more, automatic water extraction is conducted at the initiation of the next operation.

In a carbonic water production apparatus shown in FIG. 1 (circulation type) of circulating water in the bath 11 (water tank) via the carbonic acid gas dissolving apparatus 3 by the circulation pump 1 and feeding a carbonic acid gas in the carbonic acid gas dissolving apparatus 3 to dissolve the carbonic acid gas in water, setting is so made that, in initiation or completion of operation, the valve is opened for a sufficient time for extracting drain, automatically, while supplying suitable pressure for extracting drain from a carbonic acid gas feeding tube. This suitable pressure is preferably about 0.03 to 0.15 MPa. The opening time of the magnetic valve 7 suitably about 1 to 5 seconds. Further, setting may advantageously be made so that the operation time of the carbonic acid gas dissolving apparatus 3 and the drain remaining extent are recorded as data, and a time requiring drain extraction (integrated operation time) is determined, and the operation time is automatically integrated by the apparatus, and after each operation for the integrated operation time of more, automatic water extraction is conducted at the initiation of the next operation. This integrated operation time is preferably about 4 to 6 hours.

Thus, by setting time and remaining pressure corresponding to the apparatus and conducting drain extraction automatically, there is no necessity to effect manual drain extraction purposely as in conventional technologies, and usually, effective membrane surface area is confirmed, and carbonic water of high concentration can be produced simply.

[Embodiments of Feeding to a Plurality of Use Points in the First to the Fourth Present Inventions]

In the first to fourth present inventions described above, also useful embodiment is application as an apparatus in which a carbonic water production apparatus and a water storage tank are provided, carbonic water produced in the carbonic water production apparatus is stored in the water stored tank, and carbonic water stored in the water storage tank is fed to a plurality of use points by a water conveying pump.

Namely, in conventional carbonic water production, it is usual that one carbonic water production apparatus is used for one use point (e.g., bath). Therefore, in facilities in hospitals and sanatoriums having a lot of use points set, a carbonic water production apparatus should be provided for each use point, leading necessarily to increased equipment cost. Further, use of one carbonic water production apparatus for one use point means that when a large amount of carbonic water is necessary at a time for the use point, a dissolving apparatus and the like in the carbonic water production apparatus have to be enlarged. On the other hand, in the case of application to a carbonic water production feeding system having separately a function of producing carbonic water and a function of storing water, together (carbonic water production apparatus) as described above, even if carbonic water is fed to a plurality of use points, one carbonic water production apparatus can act satisfactorily, leading to reduction in equipment cost.

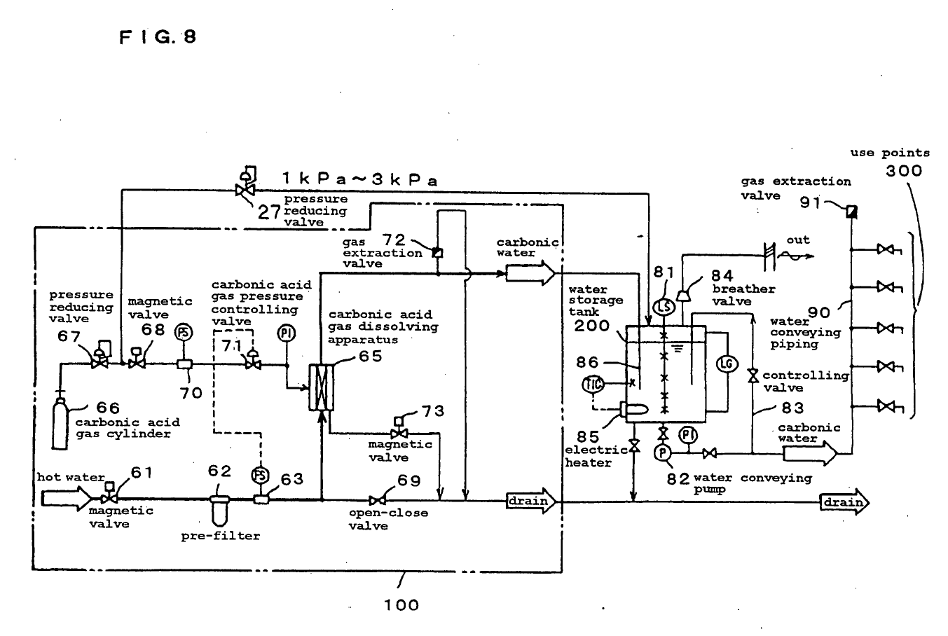

FIG. 8 is a flow sheet schematically showing one example of this embodiment. This apparatus comprises a carbonic water production apparatus 100 and a water storage tank 200 as basic constitutions. The carbonic water production apparatus 100 is a one-pass type apparatus, and in this example, hot water directly fed from a hot water faucet of water line and the like is used as raw water. This hot water is introduced into a carbonic acid gas dissolving apparatus 65 via a magnetic valve 61 which is a cut off valve in raw water feeding, a pre-filter 62 for trapping trashes in the hot water and a flow sensor 63 detecting the flow rate of hot water. On the other hand, a carbonic acid gas is fed from a carbonic acid gas cylinder 66, via a pressure-reducing valve 67, a magnetic valve 68 which is a cut off valve for a carbonic acid gas, a gas flow sensor 70 and a carbonic acid gas pressure controlling valve 71 for controlling the carbonic acid gas pressure, into a carbonic acid gas dissolving apparatus 65. It has also an automatic water extraction means (drain extraction piping, and magnetic valve (opening valve) 73 place on the way of the piping) and a gas extraction valve 72.

Next, the water storage tank 200 and use points 300 are described.

Carbonic water of high concentration (about 1000 mg/L) produced in the above-mentioned carbonic water production apparatus 100 is fed to the water storage tank 200 through piping. A feeding tube 86 for feeding the produced carbonic water to the water storage tank 200 is placed as an insertion tube in the water storage tank 200. By this, stirring of carbonic water can be prevented as completely as possible and evaporation of a carbonic acid gas in carbonic water can be prevented. When water in the water storage tank 200 reached a given water level, carbonic water production in the carbonic water production apparatus 100 is stopped by a level switch 81.

Next, carbonic water is fed centrally to use points 300 by a water conveying pump 82. A gas extracting valve 91 is mounted on the uppermost part of a water conveying tube 90, to remove the evaporated carbonic acid gas.

As the water conveying pump 82, for example, a swirling pump, diaphragm pump, screw pump, tube pump and piston pump, commonly used, are used. In driving the water conveying pump 82, return piping 83 is provided to cause constant circulation, for preventing shutoff of the water conveying pump 82 and controlling the water conveying flow rate. A part of this return piping 83 contributing to re-conveying to the water storage tank 200 is placed as an insertion tube like the feeding tube 86 for feeding carbonic water to the water storage tank 200, to prevent stirring of carbonic water as completely as possible.

Here, if the water storage tank 200 is in open system, there is a tendency that a carbonic acid gas in carbonic water vaporized to lower the concentration. Therefore, for maintaining high concentration of carbonic water in the water storage tank 200, it is preferable that a gas phase part in the tank is filled always with a carbonic acid gas. In the example shown in FIG. 8, a carbonic acid gas of about 1 kPa to 3 kPa is sealed and pressed as a gas phase in the water storage tank 200 via a pressure-reducing valve 87 from a carbonic acid gas cylinder 66. According to this constitution, when the water revel of carbonic water in the water storage tank 200 lower, a carbonic acid gas is fed into the gas phase, and when the water revel rises, discharge is effected through a breather valve 84.

The water storage tank 200 has an electric heater 85 which maintains the temperature of carbonic water at given temperature. The electric heater 85 is turned on or off by a controller.

In the water storage tank 200, if the gas pressure in a gas phase part and the temperature of carbonic water are determined, the dissolution degree of carbonic acid gas in water is constant, therefore, carbonic water always maintained at a constant concentration can be stored in the water storage tank 200. For example, when a gas phase part is composed of 100% carbonic acid gas under atmospheric pressure, the dissolution degree of carbonic acid gas in water (40° C.) is chemically 1109 mg/L (40° C.). Therefore, the concentration of carbonic acid gas in carbonic water can kept at high concentration of 1000 mg/L or more only by maintaining a gas phase part (carbonic acid gas) at atmospheric pressure, additionally, if the atmosphere in the water storage tank 200 is maintained at or around the atmospheric pressure, extreme positive pressure or negative pressure is not applied on the wall part of the water storage tank 200, therefore, the structural material of the water storage tank 200 may be made of a relatively light material, leading to reduction in equipment cost.

In this embodiment, water fed to the water storage tank 200 should be carbonic water of desired concentration. If water containing utterly no carbonic acid gas is fed to the water storage tank 200, for example, it is necessary to carry out a conventional method (pressured method) in which pressure sealing is effected in the water storage tank 200 under high pressure, to produce a carbonic acid gas, however, in this case, the water storage tank 200 is enlarged and becomes fast, and a longer period of time is necessary for production of carbonic water, therefore, stable feeding to use points can not be performed. Additionally, it is also difficult to obtain carbonic water having desired high concentration.

[Embodiments of the Fifth Present Invention]

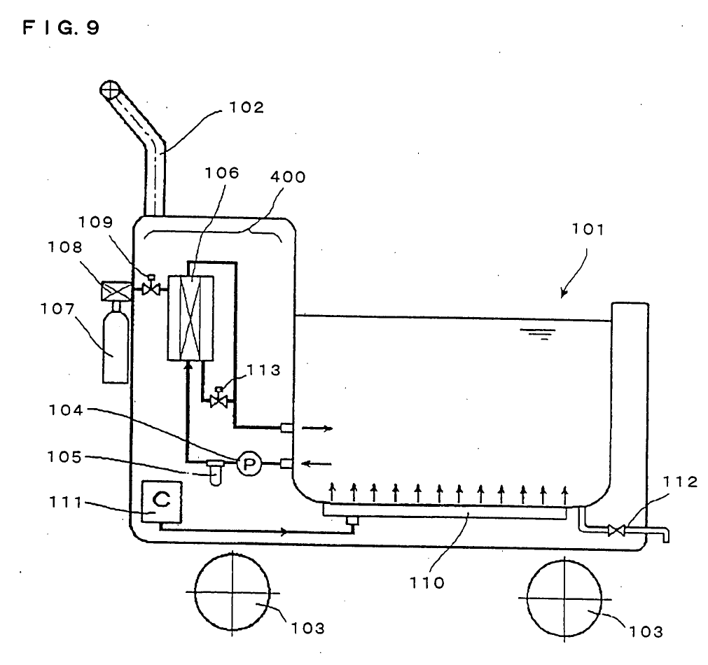

FIG. 9 is a schematic view showing one embodiment of the fifth present invention using a circulation type carbonic water production apparatus 400. This apparatus contains a carbonic water production apparatus 400 at the posterior side of a bath part 101. On its posterior upper side, a handle 102 is mounted, and castors 103 are provided under the body. By this handle 102 and castors 103, easy conveyance is possible. In this example, as the carbonic water production apparatus 400, a circulation type apparatus is used, and hot water in a bath part 101 is circulated. In the fifth present invention, the temperature of water in the bath part 101 is not particularly restricted. However, temperatures around body temperature or lower are preferable, to manifest physiological effects of carbonic water and not to apply surplus load on a diseased part. Specifically, temperatures of about 32 to 42° C. are preferable.

In the example shown in FIG. 9, hot water in this bath part 1 is absorbed by a circulation pump 104, and introduced into a carbonic acid gas dissolving apparatus 106 via a pre-filter 105 for trapping trashes in the hot water and returns again to the bath part 101. On the other hand, a carbonic acid gas is fed from a carbonic acid gas cylinder (or cartridge) 107, via a pressure-reducing valve 108 and a magnetic valve 109 which is a cut off valve for a carbonic acid gas, into a carbonic acid gas dissolving apparatus 106. The circulation pump 104 is not particularly restricted, and for example, a swirling pump, positive displacement metering pump and the like, commonly used, can be used. Since particularly the apparatus according to fifth present invention is of integrated type in which a bath itself has a carbonic water production apparatus, for example, the circulation pump 104 can be place at a position lower than the bottom of the bath. By such layout, a pump can be activated even if no priming is effected on the pump. Namely, in a circulation type carbonic water production apparatus, that a commonly used swirling pump can be used is also one of merits of the fifth present invention.

The carbonic acid gas dissolving apparatus 106 is a membrane type carbonic acid gas dissolving apparatus having a membrane module containing a hollow fiber membrane placed in it. In this example, when hot water in the bath part 101 is circulated for any time by the circulation pump 104, the bath part 101 will be filled with carbonic water having high concentration of carbonic acid gas. The volume of this bath part 101 is usually in the range from 10 to 40 L.

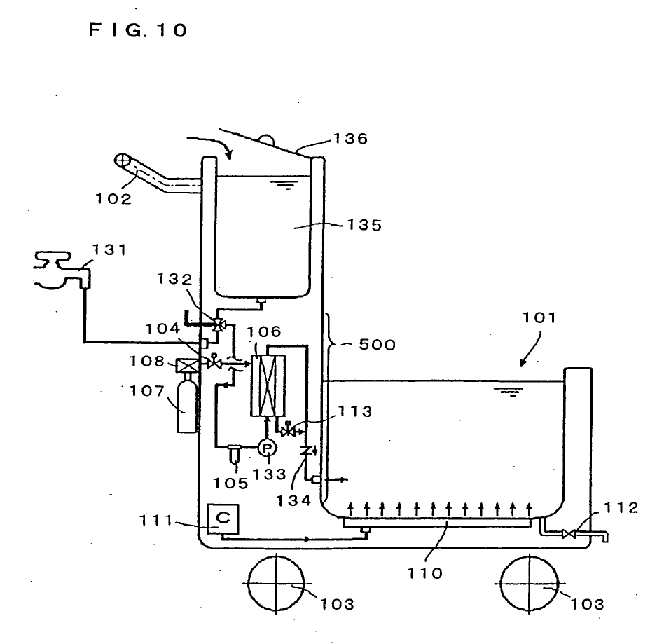

In the case of a foot bath utilizing the circulation type carbonic water production apparatus 400 as shown in FIG. 9, namely, an apparatus which comprises the carbonic acid gas dissolving apparatus 106 and circulation pump 104 and in which a carbonic acid gas is fed into the carbonic acid gas dissolving apparatus 106 while circulating water in the bath part 101 via the carbonic acid gas dissolving apparatus 106 by the circulation pump 104, to dissolve the carbonic acid gas in water, producing carbonic water, a merit is obtained in running cost as compared with a foot bath (see, FIG. 10 described later) utilizing a one-pass type carbonic water production apparatus.

Further, in this example, for example, when the water passing amount per hollow fiber membrane module is 0.1 to 10 L/min and the gas pressure is 0.01 MPa to 0.3 MPa, it is preferable that the membrane area is about 0.1 m² to 5 m².

In the foot bath shown in FIG. 9, carbonic water is produced as described above, this apparatus is used as a foot bath, then, carbonic water used is extracted from the discharge tube 102, the inner surface of the bath is washed, in preparation for the following use. Use of the same carbonic water for a plurality of patients is not preferable due to a possibility of bacterial infection. From the standpoint of shortening of discharge operation time, it is preferable that the internal diameter of the discharge tube 112 is 20 mm or more. In the example shown in FIG. 9, a bubble generation apparatus is mounted to provide one unit package, to give a multi-functional apparatus. The bubble generating apparatus is composed of, at least, a gas diffusing part 110 placed at the lower side of a bath part 1, a compressor 111 for feeding air to the gas diffusing part 110, and piping communicating both of them. By activating the compressor 111, bubble is generated from the gas diffusing part 110, and a physical stimulation is imparted to a diseased part of a patient.

In the example shown in FIG. 9, automatic water extraction means (i.e., piping for drain discharge and magnetic valve (open valve) 113) are further provided. In the case of a circulation type apparatus, it may be recommendable that the magnetic valve 113 is opened for 1 second in initiation of operation (or in completion), and drain is discharged out under suitable gas pressure. The preferable concentration of carbonic acid gas of carbonic water, constitution of the carbonic acid gas dissolving apparatus 106, constitution of a membrane module, constitution of a hollow fiber membrane, preferable range of carbonic acid gas feeding pressure, piping for counterflow washing and automatic water extraction means (i.e., piping for drain discharge and magnetic valve (open valve) 113) are the same as in the case of the first invention (FIG. 1).

FIG. 10 is a schematic view showing one embodiment of the fifth present invention using a one-pass type carbonic water production apparatus 500. In this example, hot water directly fed from a hot water faucet 131 of water line and the like is used as raw water. This hot water is introduced into a carbonic acid gas dissolving apparatus 106 via a switching valve 132 for cutting off and switching raw water feeding, a pre-filter 105 for trapping trashes in the hot water and a pump 133. On the other hand, a carbonic acid gas is fed from a carbonic acid gas cylinder (or cartridge) 107, via a pressure-reducing valve 108 and a magnetic valve 109 which is a cut off valve for a carbonic acid gas, into a carbonic acid gas dissolving apparatus 106. There is no need to use a special pump as the pump 133, and for example, a swirling pump and the like commonly used can be used. However, the pump 133 is not necessarily required in a one-bass type apparatus. Namely, if desired water pressure is obtained such as in the case of use of tap water, and the like, carbonic water can be produced by passing water to the apparatus 500 without via the pump 133. As the carbonic acid gas cylinder (or cartridge) 107, a small cylinder is preferable from the standpoint of conveyance, and that having a volume of 1 L or less is preferable.

Further, instead of use of tap water, water stored in a water storage tank 135 provided on the carbonic water production apparatus 500 can also be flown into the carbonic acid gas dissolving apparatus 106 via the switching valve 132. The volume of the water storage tank 135 is the same as that of the bath part 101 of the foot bath, and hot water is collected in the water storage tank 135 in every operation, the whole amount is fed to the bath part 101 via the carbonic water production apparatus 500. By such a function, a foot bath can be used even at a place of no water line, and a merit of a portable foot bath can be further utilized. Raw water in the water storage tank 135 has been previously fed in suitable time whole opening a lid 136.

The carbonic acid gas dissolving apparatus 106 is a membrane type carbonic acid gas dissolving apparatus having a membrane module containing a hollow fiber membrane placed in it. In this example, a carbonic acid gas fed into the carbonic acid gas dissolving apparatus 106 is introduced onto the outer surface of the hollow fiber membrane. On the other hand, raw water (hot water) fed in the carbonic acid gas dissolving apparatus 106 flows in a hollow part of the hollow fiber membrane. Here, a carbonic acid gas on the outer surface of the hollow fiber membrane comes into contact with raw water flowing in a hollow part of the hollow fiber membrane via a membrane surface, a carbonic acid gas is dissolved in raw water to produce carbonic water having desired concentration in one pass. This carbonic water is fed into the bath part 101 via a non-return valve.

The carbonic acid gas dissolving apparatus may have a constitution in which a carbonic acid gas is fed in a hollow fiber membrane and raw water is flown to the outside of a hollow fiber membrane, contrary to the above-mentioned constitution.

In the case of a foot bath utilizing the one-pass type carbonic water production apparatus 500 as shown in FIG. 10, namely, an apparatus which comprises the carbonic acid gas dissolving apparatus 106 and in which a carbonic acid gas is fed into the carbonic acid gas dissolving apparatus 106 from either a raw water feeding port communicating with a faucet 131 or a water storage tank 136 while flowing raw water to dissolve the carbonic acid gas in water, producing carbonic water, a merit that microbial infection in the apparatus does not occur easily is obtained as compared with a foot bath utilizing the circulation type carbonic water production apparatus 400 shown in FIG. 9. When the one-bass type carbonic water production apparatus 500 is used, carbonic water production time can be shortened as compared with the case of use of a circulation type apparatus, and the apparatus 500 is very useful, for example, when treatment of a lot of patients is necessary.

In automatic water extraction (drain extraction) in FIG. 10, after stopping of feeding of a carbonic acid gas, after given time lapsed (for example, after 10 seconds), a magnetic valve 73 is opened for 5 seconds, and drain is discharged out by the remaining pressure of a gas in outside of a hollow fiber membrane.

In the examples shown in FIGS. 9 and 10, the carbonic water production apparatuses 400 and 500 are preferable detachable from the body of a foot bath from the standpoints of maintenance, expendable item exchange, and the like. Specifically, it may be recommendable that it is integrated into a panel composed of only angle to give a unit in the form of box (skid) which can be removed out simply.

The carbonic water production apparatuses equipped with foot baths as shown in FIGS. 9 and 10 described above are of very suitable form since a carbonic water production apparatus, bath and gas cylinder are integrated into a unit, portableness is obtained, and carbonic water bathing can be carried out simply without selecting place. Patient utilizing foot bathing often have ischemic ulcer due to peripheral blood cell circulation deficiency, and often use a wheel chair. Therefore, it is preferable that the apparatus of the present invention also has a size corresponding to a wheel chair. For example, a wheel chair is usually equipped with foot rests. It is convenient that if, in foot-bathing, these foot rests are lifted on both sides, and a foot bath can be inserted into a wheel chair. In this case, the width of a foot bath should be not more than the inner size when foot rests are lifted at both sides. Therefore, specifically, the width of a foot bath is preferably from about 300 to 350 mm. For example, the height and depth of a foot bath advantageously be set so that a patient on a wheel chain can insert feet into the foot bath smoothly and feet can be bathed as deeply as possible. Therefore, specifically, the height of a foot bath is preferably from about 350 to 450 mm, and the depth of a bath is preferably from about 250 to 350 mm.

The present invention will be illustrated further specifically by examples below.

First, Example A regarding the first present invention will be described.

### EXAMPLE A1

Using the apparatus shown in the flow sheet of FIG. 1, carbonic water was produced as described below. As the carbonic acid gas dissolving apparatus 3, a dissolving apparatus was used containing the three-layer complex hollow fiber membrane described above [manufactured by Mitsubishi Rayon Co., Ltd., trade name: MHF] at an effective total membrane area of 0.6 m², and a carbonic acid gas was fed on the outer surface side of the hollow fiber membrane and raw water was fed to the hollow side, to dissolve the carbonic acid gas. As the circulation pump 1, a 3-head diaphragm pump manufactured by SHURflo, a diaphragm mode metering pump, was used.

Hot water having an amount of 10 L and a temperature of 35° C. filled in the bath 11 was circulated at a flow rate of 5 L/min by the circulation pump 1, and simultaneously, a carbonic acid gas was fed under a pressure of 0.05 MPa to the carbonic acid gas dissolving apparatus 5. By this circulation, the concentration of carbonic acid gas in hot water in the bath 11 increased gradually. The concentration of carbonic acid gas was measured by an ion meter IM40S manufactured by Toa Denpa Kogyo K.K., carbonic acid gas electrode CE-235. The measurement results of the concentration of carbonic acid gas at every circulation time are shown in Table 1. In production of carbonic water, drain extraction was conducted automatically by an automatic water extraction function, and gas extraction was appropriately conducted.

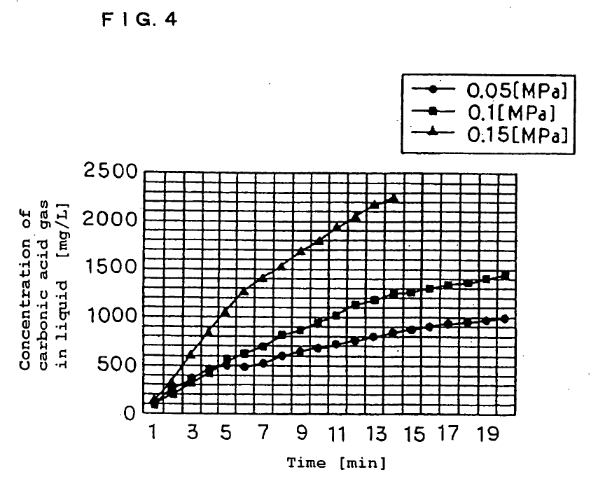

Further, carbonic water was produced in the same manner excepting that the feeding pressure of carbonic acid gas was changed to 0.10 MPa and 0.15 MPa. The circulation time and the concentration of carbonic acid gas in this case are also shown in Table 2. These are shown in the form of graph in FIG. 4.

TABLE 1
Correlation of circulation time and concentration
of carbonic acid gas

| | | Concentration of carbonic acid gas [mg/L] | | |
|---|---|---|---|---|
| | | Gas feeding | Gas feeding | Gas feeding |
| | | pressure | pressure | pressure |
| | | 0.05 MPa | 0.1 MPa | 0.15 MPa |
| Circulation time. min | 1 | 119 | 94 | 92.8 |
| | 2 | 254 | 200 | 335 |
| | 3 | 358 | 319 | 607 |
| | 4 | 437 | 428 | 848 |
| | 5 | 499 | 548 | 1057 |
| | 6 | 490 | 623 | 1265 |
| | 7 | 521 | 697 | 1410 |
| | 8 | 594 | 814 | 1531 |
| | 9 | 648 | 873 | 1699 |
| | 10 | 691 | 945 | 1802 |
| | 11 | 721 | 1029 | 1937 |
| | 12 | 763 | 1135 | 2050 |
| | 13 | 812 | 1189 | 2190 |
| | 14 | 839 | 1250 | 2260 |
| | 15 | 883 | 1270 | |
| | 16 | 912 | 1308 | |
| | 17 | 932 | 1351 | |
| | 18 | 949 | 1372 | |
| | 19 | 976 | 1406 | |
| | 20 | 1008 | 1447 | |

Based on the data shown in Table 1, for example, if the concentration the intended carbonic acid gas to be produced is 1000 mg/L, the desired times for circulation are determined as shown in Table 2 for feeding pressures of carbonic acid gas of 0.05 MPa, 0.10 MPa and 0.15 MPa, respectively.

TABLE 2

| Feeding pressure of | Concentration of | Necessary |
|---|---|---|
| carbonic acid gas | carbonic acid gas | time |
| 0.05 MPa | 1008 mg/L | 20 min. |
| 0.10 MPa | 1029 mg/L | 11 min. |
| 0.15 MPa | 1057 mg/L | 5 min. |

In the first present invention, since a positive displacement metering pump having a self-priming ability is used, carbonic water having a high concentration of about 1000 mg/L can also be circulated stably. Therefore, when water was again circulated for desired times under three gas feeding pressures shown in Table 2, carbonic water having a high concentration of about 1000 mg/L could be produced.

### Comparative Example A1

Carbonic water was tried to be produced in the same manner as in Example A1 excepting that a swirling pump was used instead of a diaphragm type metering pump, as the circulation pump 1, and an under-water pump (swirling mode) was attached also at the tip of an absorption horse in a bath for making the pressure at a pump absorption port positive (pushing). However, before reaching carbonic water (1000 mg/L) of high concentration, the pump stopped due to generation of bubble.

A time from initiation of operation until stopping of a swirling pump by bubble entrainment, and the concentration of carbonic acid gas at its stopping are shown in Table 3.

TABLE 3

| Feeding pressure of | Stop | Reached |
|---|---|---|
| carbonic acid gas | time | concentration |
| 0.05 MPa | 12 min. | 624 mg/L |
| 0.10 MPa | 4 min. | 750 mg/L |
| 0.15 MPa | 3 min. | 678 mg/L |

From the results shown in Table 3, it is known that, when a swirling pump is used, the concentration of carbonic water increases and the pump is stopped by bubble, consequently, that having a high concentration of about 1000 mg/L cannot be produced.

As described above, in the first present invention, since a positive-displacement metering pump is used, even if bubble is generated in carbonic water of high concentration, stable circulation is possible. Further, complicated control is not necessary, the constitution of the apparatus can be simplified significantly, the apparatus has small size and requires low cost, and carbonic water of high concentration can be produced by a simple operation at low cost. Further, as compared with a one-pass type apparatus, setting is simple, and carbonic water can be produced more efficiently at low cost with low gas feeding pressure. From such a standpoint, the first present invention is very useful as the domestic carbonic water production apparatus since, for example, it can be used only by filling a bath with hot water and putting a carbonic water circulation hose of the apparatus.

Next, Example B regarding the second present invention will be described.

### EXAMPLE B1

The carbonic water production process according to the second present invention shown in FIG. 5 was carried out as described below.

As the carbonic acid gas dissolving apparatus 24, a dissolving apparatus was used containing the three-layer complex hollow fiber membrane described above [manufactured by Mitsubishi Rayon Co., Ltd., trade name: MHF] at an effective total membrane area of 2.4 m², and a carbonic acid gas was fed on the outer surface side of the hollow fiber membrane and raw water was fed to the hollow side, to dissolve the carbonic acid gas. As the filtration apparatus 26, RAF-40N (trade name, manufactured by Noritz Corp., ability: 4 t/H (67 L/min), 400 W) was used, as the circulation pump 22, a commonly used swirling pump (270 W) was used, and as the bath 21, a large bath having a volume of 1000 L (1 m³) was used. An early step was carried out at a water temperature of 40° C., a circulation flow rate of 10 L/min/m² and a carbonic acid gas pressure of 0.2 MPa for 1 hour, consequently, the bath can be filled with carbonic water having a concentration of carbonic acid gas of 810 mg/L. Subsequently, a concentration maintaining step was carried out at a carbonic acid gas pressure of 0.1 MPa, and the concentration of carbonic acid gas in carbonic water in the bath could be maintained at 840 to 880 mg/L for 5 hours. The specific data in this example are shown in Table 4 below.

TABLE 4

| Lapsed time | Pressure of carbonic | Concentration of |
|---|---|---|
| (hour:min) | acid gas | carbonic acid gas |
| 0:00 | 0.2 MPa | 10 mg/L |
| 0:30 | 0.2 MPa | 480 mg/L |
| 1:00 | 0.1 MPa | 810 mg/L |
| 1:30 | 0.1 MPa | 840 mg/L |
| 2:00 | 0.1 MPa | 850 mg/L |
| 2:30 | 0.1 MPa | 850 mg/L |
| 3:00 | 0.1 MPa | 860 mg/L |
| 3:30 | 0.1 MPa | 860 mg/L |
| 4:00 | 0.1 MPa | 870 mg/L |
| 4:30 | 0.1 MPa | 870 mg/L |
| 5:00 | 0.1 MPa | 870 mg/L |
| 5:30 | 0.1 MPa | 870 mg/L |
| 6:00 | 0.1 MPa | 880 mg/L |

As described above, according to the second present invention, a problem of evaporation of a carbonic water after once produced can be solved, and a certain concentration of carbonic acid gas can be produced and maintained by a simple operation at low cost for a long period of time.

Next, Example C regarding the third present invention will be described.

### EXAMPLE C1

Carbonic water was produced as described below using the apparatus according to the flow sheet shown in FIG. 6. As the carbonic acid gas dissolving apparatus 45, a dissolving apparatus was used containing the three-layer complex hollow fiber membrane described above [manufactured by Mitsubishi Rayon Co., Ltd., trade name: MHF] at an effective total membrane area of 2.4 m², and a carbonic acid gas was fed on the outer surface side of the hollow fiber membrane and raw water was fed to the hollow side, to dissolve the carbonic acid gas.

First, the intended concentration of carbonic acid gas of carbonic water to be produced was set at 600 mg/L. Next, hot water (raw water) prepared by heating tap water at 40° C. was fed to the carbonic acid gas dissolving apparatus 45 at any flow rate. The flow rate of the hot water detected by the flow sensor 4 was 15 L/min.

A carbonic acid gas was fed to the carbonic acid gas dissolving apparatus 45 while automatically controlling the feeding pressure of carbonic acid gas so the concentration of carbonic acid gas of the resulting carbonic water was 600 mg/L, based on this flow rate data and the correlation data shown in FIG. 7 previously recorded. The feeding pressure of carbonic acid gas in this operation was specifically 0.16 MPa. The concentration of carbonic acid gas of carbonic water thus produced was measured by an ion meter IM40S manufactured by Toa Denpa Kogyo K.K., carbonic acid gas electrode CE-235. The results are shown in Table 5. In production of carbonic water, drain extraction was conducted automatically by an automatic water extraction function, and gas extraction was appropriately conducted.

Further, carbonic water was produced in the same manner excepting that the intended concentration of carbonic acid gas was set at 1000 mg/L (flow rate of hot water: 15 L/min). The feeding pressure of carbonic water was specifically 0.30 MPa. The concentration of carbonic acid gas of thus produced carbonic water was measured in the same manner. The results are shown in Table 5.

TABLE 5
Flow rate of hot water is 15 L/min

| Set | Feeding pressure of | Actually measured |
|---|---|---|
| concentration | carbonic acid gas | concentration |
| 600 mg/L | 0.16 MPa | 640 mg/L |
| 1000 mg/L | 0.30 MPa | 1090 mg/L |

As apparent from the results shown in Table 5, carbonic water having the intended concentration could be produced with little error, in any set concentration case.

### EXAMPLE C2

Carbonic water was produced in the same manner as in Example C1 excepting that the flow rate of hot water was 5 L/min. The results are shown in Table 6.

TABLE 6
Flow rate of hot water is 5 L/min

| Set | Feeding pressure of | Actually measured |
|---|---|---|
| concentration | carbonic acid gas | concentration |
| 600 mg/L | 0.05 MPa | 615 mg/L |
| 1000 mg/L | 0.14 MPa | 1050 mg/L |

As apparent from the results shown in Table 6, carbonic water having the intended concentration could be produced with little error, in any set concentration case. From the results of Examples C1 and C2, it is also known that carbonic water having the intended concentration can be produced with little error, even if the flow rate of hot water (raw water) is indefinite.

As described above, according to the third present invention, complicated control is not necessary, the constitution of the apparatus can be simplified significantly, the apparatus has small size and requires low cost, and carbonic water having the intended concentration of carbonic acid gas can be produced by a simple manner. Particularly, the third present invention can be applied also when raw water is fed from a faucet of water line, additionally, since the apparatus is compact, it is very useful as an apparatus for water treatment which can be applied simply to known baths including a domestic bath.

Next, Example D regarding the fourth present invention will be described.

### EXAMPLE D1

Carbonic water was produced using the apparatus according to the flow sheet shown in FIG. 6. As the carbonic acid gas dissolving apparatus 45, a dissolving apparatus was used containing the three-layer complex hollow fiber membrane described above [manufactured by Mitsubishi Rayon Co., Ltd., trade name: MHF] at an effective total membrane area of 2.4 m², and a carbonic acid gas was fed on the outer surface side of the hollow fiber membrane and raw water was fed to the hollow side, to dissolve the carbonic acid gas.

First, the intended concentration of carbonic acid gas of carbonic water to be produced was set at 1000 ppm. Next, hot water (raw water) prepared by heating tap water at 40° C. was fed to the carbonic acid gas dissolving apparatus 45 at any flow rate. The flow rate of the hot water detected by the flow sensor 43 was 15 L/min. Here, a carbonic acid gas was fed to the carbonic acid gas dissolving apparatus 45 while appropriately controlling the feeding pressure of carbonic acid gas so the concentration of carbonic acid gas of the resulting carbonic water was 1000 mg/L. The feeding pressure of carbonic water was specifically 0.30 MPa. The concentration of carbonic acid gas of thus produced carbonic water was about 1000 ppm.

This carbonic water production was continued for 1 hour, then, feeding of raw water and feeding of carbonic acid gas were stopped. As intended, 10 seconds after this stopping timing, the magnetic valve 53 of the apparatus was opened automatically for 5 seconds. In this operation, drain was discharged successfully out of the apparatus, under a remaining pressure of a gas out of a hollow fiber membrane in the carbonic acid gas dissolving apparatus 45 at about 0.05 MPa. Further, no hammer phenomenon occurred.

### EXAMPLE D2

Carbonic water was produced using the apparatus according to the flow sheet shown in FIG. 3. As the carbonic acid gas dissolving apparatus 3, a dissolving apparatus was used containing the three-layer complex hollow fiber membrane described above [manufactured by Mitsubishi Rayon Co., Ltd., trade name: MHF] at an effective total membrane area of 0.6 m², and a carbonic acid gas was fed on the outer surface side of the hollow fiber membrane and raw water was fed to the hollow side, to dissolve the carbonic acid gas.

Hot water having an amount of 10 L and a temperature of 35° C. filled in the bath 11 was circulated at a flow rate of 5 L/min by the circulation pump 1, and simultaneously, a carbonic acid gas was fed under a pressure of 0.15 MPa to the carbonic acid gas dissolving apparatus 3. By this circulation, the concentration of carbonic acid gas in hot water in the bath 11 increased gradually. When this circulation was continued for 5 minutes, the concentration of carbonic water in the bath reached around 1000 ppm. Since operation was repeated for several time (integration time: 4 hours or more); drain was collected in the carbonic acid gas dissolving apparatus 3 after production of carbonic water. In completion of the next operation, the magnetic valve 7 was automatically opened for 1 second, as set. Since, in this time, the carbonic acid gas magnetic valve 6 was opened, a gas pressure of 0.15 MPa was applied, and under this pressure, the drain was discharged successfully out of the apparatus. Further, the same carbonic water production was repeated, consequently, after every operation for an integrated operation time of 4 hours of more, water extraction was successfully conducted automatically in initiation of the next operation, as set.

As described above, according to the fourth present invention, effective membrane area can be always secured, without requiring effecting purposely manual drain extraction, and carbonic water of high concentration can be successfully produced by a simple operation, namely, the fourth present invention is very practical.

Next, Example E in which feeding to a plurality of use points is conducted will be described.

### EXAMPLE E1

Carbonic water was produced and fed as described below, according to the example shown in FIG. 8. In the carbonic water production apparatus 100, as the carbonic acid gas dissolving apparatus 65, a dissolving apparatus was used containing the three-layer complex hollow fiber membrane described above [manufactured by Mitsubishi Rayon Co., Ltd., trade name: MHF] at an effective total membrane area of 2.4 m², and a carbonic acid gas was fed on the outer surface side of the hollow fiber membrane and raw water was fed to the hollow side, to dissolve the carbonic acid gas. The water storage tank 200 was a tank in the form of cylinder having an inner volume of 1000 L. The carbonic acid gas saturation concentration in the water storage tank 200 is about 1100 mg/L at 40° C. under atmospheric pressure, the production concentration in the carbonic water production apparatus 100 was 1000 mg/L. The number of use points were 5 in total, water is fed via each point into each bath of 250 L, it is supposed water can be fed at a maximum rate of about 15 L/min at each use point, and a commonly used swirling pump having a water conveying ability of 100 L/min was used as the water conveying pump 82.

First, hot water (raw water) prepared by heating tap water at 40° C. was fed to the carbonic acid gas dissolving apparatus 65 at a flow rate of 15 L/min, and a carbonic acid gas was fed to the carbonic acid gas dissolving apparatus 65 under a feeding pressure of 0.30 MPa. The concentration of carbonic acid gas of the produced carbonic water was about 1000 ppm, and this was fed to the water storage tank 200. Carbonic water in the water storage tank 200 was kept at 40° C. This carbonic water could be successfully fed to each use point 300 by the water conveying pump 82.

As described above, in this example, equipment cost could be reduced by one carbonic water production apparatus even when carbonic water was fed to a plurality of use points (e.g., bath). Namely, by effecting such an application, operation can be carried out by one carbonic water production apparatus, even in a facility having a lot of use points provided, and a large amount of carbonic water can be stored in a water storage tank, therefore, even when a large amount of carbonic water is necessary at one time, a small dissolving apparatus can be used in a carbonic water production apparatus, and by this, equipment cost lowers. Further, carbonic water of high concentration giving physiological effects can be supplied easily in a stable manner.

Next, Example F regarding the fifth present invention will be described.

### EXAMPLE F1

A foot bath using the circulation type carbonic water production apparatus shown in FIG. 9 was produced as described below and used. In the carbonic water production apparatus 400, as the carbonic acid gas dissolving apparatus 106, a dissolving apparatus was used containing the three-layer complex hollow fiber membrane described above [manufactured by Mitsubishi Rayon Co., Ltd., trade name: MHF] at an effective total membrane area of 0.6 m², and a carbonic acid gas was fed on the outer surface side of the hollow fiber membrane and raw water was fed to the hollow side, to dissolve the carbonic acid gas. As the circulation pump 104, a commonly used swirling pump (magnet pump manufactured by Iwaki) was used. The size of the foot bath was set within the above-mentioned range corresponding to a wheel chair, and hot water was circulated for 3 minutes at a bath volume of 11 L, a water temperature of 40° C. and a circulation flow rate of 5.4 L/min, consequently, the bath was filled with carbonic water having concentration shown in Table 7 below.

TABLE 7

| Pressure of carbonic | Concentration of |
|---|---|
| acid gas | carbonic acid gas |
| 0.1 MPa | 520 mg/L |
| 0.2 MPa | 815 mg/L |

The concentration of carbonic acid gas is a value measured by a measuring apparatus (IM-40) manufactured by Toa Denpa K.K.

### EXAMPLE F2

A foot bath using the one-pass type carbonic water production apparatus shown in FIG. 10 was produced as described below and used. In the carbonic water production apparatus 500, as the carbonic acid gas dissolving apparatus 106, a dissolving apparatus was used containing the three-layer complex hollow fiber membrane described above [manufactured by Mitsubishi Rayon Co., Ltd., trade name: MHF] at an effective total membrane area of 0.6 m², and a carbonic acid gas was fed on the outer surface side of the hollow fiber membrane and raw water was fed to the hollow side, to dissolve the carbonic acid gas. The size of the foot bath was set within the above-mentioned range corresponding to a wheel chair, and the water temperature was controlled to 40° C., the raw water flow rate was controlled to 5.4 L/min, and the carbonic acid gas pressure was controlled to 0.2 MPa, then, carbonic water having a concentration of carbonic acid gas of 794 mg/L could be filled in the bath.

As described above, according to the fifth present invention, a bath can be provided of which operation in use is simple and which keeps sufficiently the merit of portable foot baths.

1-3. (canceled)

4. A carbonic water production method which comprises circulating water in a water tank through a carbonic acid gas dissolving apparatus by a circulation pump, and feeding a carbonic acid gas into the carbonic acid gas dissolving apparatus to dissolve the carbonic acid gas in the water, and which is characterized by comprising
an early step of applying a necessary pressure of the carbonic acid gas in order to produce a carbonic water having a desired concentration of carbonic acid gas, in the early circulation of the water for producing the carbonic water, and
a concentration maintaining step of applying a necessary pressure of the carbonic acid gas and circulating the carbonic water in order to maintain the desired concentration of carbonic acid gas of the carbonic water produced at the early step.

5. The carbonic water production method according to claim 4, wherein the necessary pressure of carbonic acid gas in the concentration maintaining step is lower than the necessary pressure of carbonic acid gas in the early step.

6. The carbonic water production method according to claim 5, wherein the necessary pressure of carbonic acid gas in the early step is 0.15 to 0.3 MPa, and the necessary pressure of carbonic acid gas in the concentration maintaining step is 0.001 to 0.1 MPa.

7. A carbonic water production apparatus which feeds a carbonic acid gas into a carbonic acid gas dissolving apparatus thereof while flowing a raw water therein to dissolve the carbonic acid gas in the raw water, and which is characterized by being previously recorded a correlation data of the flow rate of raw water with the feeding pressure of carbonic acid gas and the concentration of carbonic acid gas in resulted carbonic water, and is equipped with a means for detecting the flow rate of raw water and controlling the feeding pressure of carbonic acid gas according to the correlation data so that the resulted carbonic water has an intended concentration of carbonic acid gas at the time of producing the carbonic water.

8. A carbonic water production method which comprises feeding a carbonic acid gas into a carbonic acid gas dissolving apparatus while flowing a raw water to dissolve the carbonic acid gas in the raw water, and which is characterized by comprising a step of previously recording a correlation data of the flow rate of raw water with the feeding pressure of carbonic acid gas and the concentration of carbonic acid gas in resulted carbonic water, and a step of detecting the flow rate of raw water and controlling the feeding pressure of carbonic acid gas according to the correlation data so that the resulted carbonic water has an intended concentration of carbonic acid gas at the time of producing the carbonic water.

9. The carbonic water production method according to claim 8, wherein the intended concentration of carbonic acid gas is in the range from 600 mg/L to 1400 mg/L.

10. The carbonic water production apparatus according to claim 7, wherein the carbonic acid gas dissolving apparatus is a membrane type carbonic acid gas dissolving apparatus.

11. The carbonic water production apparatus according to claim 10, wherein the membrane type carbonic acid gas dissolving apparatus is a carbonic acid gas dissolving apparatus having a non-porous gas permeable membrane.

12. The carbonic water production method according to any of claims 2 to 6, 8 and 9, wherein the carbonic acid gas dissolving apparatus is a membrane type carbonic acid gas dissolving apparatus.

13. The carbonic water production method according to claim 12, wherein the membrane type carbonic acid gas dissolving apparatus is a carbonic acid gas dissolving apparatus having a non-porous gas permeable membrane.

14. A carbonic water production apparatus which is equipped with a membrane type carbonic acid gas dissolving apparatus, and which is characterized by being equipped with an automatic water extraction means for automatically discharging out the drain accumulated in the membrane type carbonic acid gas dissolving apparatus.

15. A carbonic water production method which applies a membrane type carbonic acid gas dissolving apparatus, and which is characterized by comprising a step of automatically discharging out the drain accumulated in the membrane type carbonic acid gas dissolving apparatus.

16. The carbonic water production apparatus according to claim 7 or 14, which is further equipped with a bubble generation apparatus or an injection apparatus.

17. The carbonic water production apparatus according to claim 7 or 14, which is equipped with a carbonic water production apparatus and a water storage tank, and wherein a carbonic water produced by the carbonic water production apparatus is stored in the water storage tank, and then the carbonic water stored in the water storage tank is fed to a plurality of use points by a water conveying pump.

18. The carbonic water production apparatus according to claim 17, wherein a gas phase inside of the water storage tank is filled with a carbonic acid gas and kept at a gas pressure of 1 kPa to 3 kPa.

19. The carbonic water production apparatus according to claim 17, wherein a carbonic acid gas is additionally fed into the gas phase inside of the water storage tank when the water level of carbonic water inside of the water storage tank is downed, and the carbonic acid gas of the gas phase inside the water storage tank is partially discharged when the water level of carbonic water inside of the water storage tank is upped.

20. The carbonic water production apparatus according to claim 17, which is equipped with an insertion tube inside of the water storage tank wherein the tube feeds the carbonic water produced by the carbonic water production apparatus into the water storage tank.

21. A carbonic water production apparatus which is characterized by being combined with a portable foot bath.

22. The carbonic water production apparatus according to claim 21, which is equipped with a handle and casters for portage.

23. The carbonic water production apparatus according to claim 21, which is equipped with a carbonic acid gas cylinder having a volume of 1 L or less, or a cartridge type carbonic acid gas cylinder.

24. The carbonic water production apparatus according to claim 21, which can be freely separated from the portable foot bath.
